(19) United States
(12) Patent Application Publication
(10) Pub. No.: US 2004/0172295 A1
(43) Pub. Date: Sep. 2, 2004

(54) Electronic prescription system

(75) Inventors: Michael Dahlin, Austin, TX (US); Eric Wohl, Austin, TX (US); Randolph Lipscher, Austin, TX (US)

Correspondence Address: TOLER & LARSON & ABEL L.L.P., 5000 PLAZA ON THE LAKE STE 265, AUSTIN, TX, 78746, US

(73) Assignee: RECARE, INC.

(21) Appl. No.: 10/725,357

(22) Filed: Dec. 1, 2003

Related U.S. Application Data
(60) Provisional application No. 60/430,454, filed on Dec. 3, 2002.

(51) Int. Cl. G06F 17/60

(52) U.S. Cl. 705/2

(57) ABSTRACT

In a particular embodiment, the disclosure is directed to an electronic device. The electronic device includes a touch responsive display and a graphical user interface (GUI) engine. The GUI engine is operable to initiate presentation of a GUI on the display. The GUI comprises a first portion presenting a menu-based interface and a second portion having an area for receiving a prescription input comprising a handwritten character.

### CROSS-REFERENCE TO RELATED APPLICATION(S)

The present application claims priority from U.S. provisional patent application No. 60/430,454, filed Dec. 3, 2002, entitled “Electronic prescription system,” naming inventors Michael Dahlin, Eric Wohl and Randolph Lipscher, which application is incorporated by reference herein in its entirety.

### TECHNICAL FIELD

The present disclosure, in general, relates to electronic prescription systems. More specifically, the invention relates to an electronic prescription system with integrated advertising, education, verification and prescription transfer.

### BACKGROUND

Integrated networks and increased use of electronic devices and computers. in medical facilities has increased the possibilities for integrated medical record and pharmaceutical prescription systems. These systems gather information and store the data for use in cataloging patient visits, test results, billing information, allergies and other conditions, and various other medical data. One application is prescription services.

Typical electronic prescription pads are self-contained units not connected to a network. They general contain data files associated with preparing prescriptions. Often, these units must be attached to a computer to update the prescription files and these systems require frequent updating to maintain an up-to-date database. The devices are also easily stolen and, as such, have limited security.

In addition, the lack of connectivity limits access by advertisers to provide context specific advertising. When a specific ailment is found in a patient, doctors may not know about the newest or most effective treatment. However, advertisers are limited in their access to doctors for both presenting the option and educating doctors about the treatment. Pharmaceutical companies are also interested in locating patients for drug trials. Drug trials are often expensive and require the location of patients with specific profiles and ailments. Experimental drugs must often be administered to patients at a specific point in the disease process. Typical prescription pad systems fail to provide context-based treatment information and as such, limit access by advertisers and drug trials.

Furthermore, the devices are often not integrated with other medical systems. As such, the devices may not be connected to allergy or existing prescription data associated with a specific patient. As such, these typical devices may fail to notify a doctor if an interaction or allergy exists.

In some cases, doctors tend to prescribe the most critical or obvious drug for a disease or diagnosis, but often a patient has a set of related issues to be addressed. Generally, typical prescription systems leave doctors unaware of alternative and cooperative therapies.

As such, an improved electronic prescription system and method would be desirable.

### BRIEF DESCRIPTION OF DRAWINGS

For a more complete understanding of the present invention and advantages thereof, reference is now made to the following description taken in conjunction with the accompanying drawings in which like reference numbers indicate like features and wherein:

FIGS. 1-4 are block diagrams depicting exemplary prescription systems.

FIGS. 5-7 are block flow diagrams depicting exemplary method for use in a prescription system.

FIGS. 8-10 are pictorial representations of exemplary interface pages.

FIGS. 11-13 are block flow diagrams depicting exemplary method for use in a prescription system.

FIGS. 14-27 are pictorial representations of exemplary interface pages.

FIG. 28 is a block flow diagram depicting exemplary method for use in a prescription system.

FIGS. 29-32 are pictorial representations of exemplary interface pages.

FIG. 33 is a block flow diagram depicting an exemplary method for use in a prescription system.

FIGS. 34-38 are pictorial representations of exemplary interface pages.

FIGS. 39A, 39B, and 40 are block flow diagrams of exemplary methods for use in a prescription system.

FIG. 41 is a pictorial representation of an exemplary interface page.

FIG. 42 is a block diagram depicting an exemplary prescription system.

FIGS. 43-35 are pictorial representations of exemplary interface pages.

FIG. 46 is a block flow diagram depicting an exemplary method for use in a prescription system.

FIGS. 47-50 are pictorial representations of exemplary interface pages.

FIG. 51 is a block diagram depicting an exemplary prescription system.

### DETAILED DESCRIPTION

### System Architecture

The present invention is directed to a prescription pad system that enables medical professionals to enter prescriptions quickly, accurately, and with relevant information.

FIG. 1 depicts an electronic prescription system in which one or more user input systems 102 provides access to a prescription system 104 that generates prescriptions based on user input and transmits prescriptions to one or more output systems 106.

A user input system 102 provides a means for a user to provide input to the system. In one embodiment, the user input system 102 comprises a display screen and at least one input device such as a mouse, touchpad, touch screen, light pen, voice capture microphone, keyboard, virtual on-screen keyboard, or handwriting capture device. For example, the user input system 102 may be a portable computer, a tablet computer, a handheld computer, a personal digital assistant, a laptop, a desktop computer, or a portable circuitry such as a smart phone. In one exemplary embodiment, the user input system 102 may include a wireless network connection.

An output system 106 transmits one or more prescriptions created by the prescription system to external systems. In one embodiment, the output system 106 comprises at least one means for transmitting a prescription to at least one of a printer, a fax, a pharmacy computer, a payor computer, and a patient computer. Means of such transmission will be known to those familiar with the art. In one embodiment, transmission is via a network such as a wireless network, wired network, ATM network, Ethernet, phone network, mobile phone network, internetwork connecting multiple networks. In one embodiment, transmission is via at least one intermediary computer such as an HTTP server to which the prescription system transmits one or more prescriptions and from which a patient, pharmacy, or payer can view a prescription. In another embodiment, the at least one intermediary computer forwards prescriptions it receives to a remote computer. In a further embodiment, the at least one intermediary computer forwards prescriptions it receives to a printer device or fax transmission device. Means for encoding prescriptions by the output system will be known by those familiar with the art. In one embodiment, an output encoding is selected from a group of output encodings that includes postscript, portable document format (PDF), hypertext markup language (HTML), extensible markup language (XML), java serialization, or ASCII.

The prescription system 104 receives input from at least one user input system 102 and sends prescriptions to at least one output system 106. In an embodiment, the prescription system 104 includes routines to allow the user input to select medications and select prescribing parameters for the medications and a routine to transmit one or more prescriptions to one or more output systems. The prescription system 104 may store information regarding medications including a medication identifier (e.g., the medication name, trade-name, or unique key) and one ore more parameters about the medication (e.g., the available/allowable route, dosage, frequency, etc.). The prescription system 104 may store routines for organizing, filtering, selecting, and displaying medications, such as different groupings of medications (e.g., by hot list, by disease, by category, by alphabetical name, by formulary, by category); such as rules for filtering displayed medications based on information about the patient, business rules, or medical rules; such as additional information about medications such as medication abstracts, research reports, or advertisements; or such as default parameter values. In addition, the prescription system 104 may include an authentication or authorization engine operable to compare handwriting, such as signatures, to a stored sample or parameters to authenticate or authorize a prescription.

A medication parameter is an aspect of a prescription that is specified to describe the administration of the medication. Examples of parameters relevant to some medications include the form, route, frequency, refills, and dosage. A parameter value is a selected value for a parameter. For example, the parameter value “4 mg” may be the value for the parameter “dosage”.

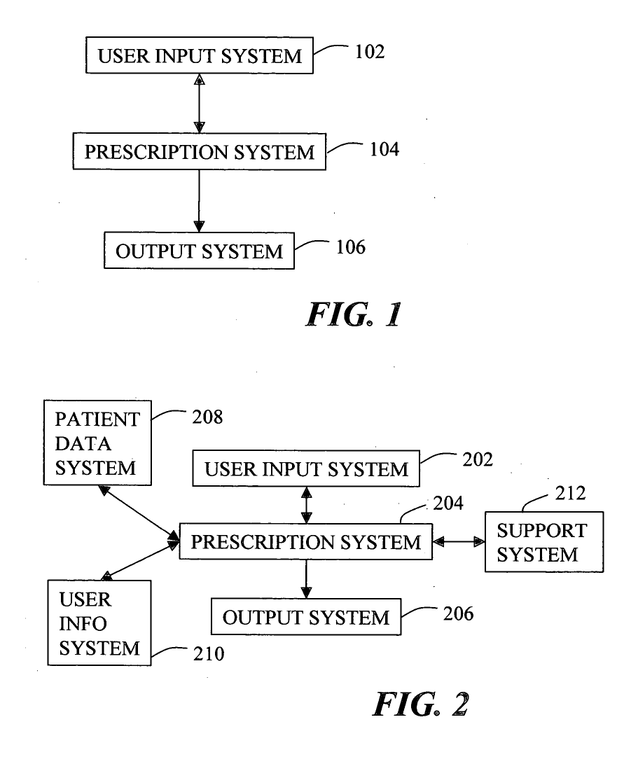

FIG. 2 depicts an embodiment with three additional subcomponents: a patient data system 208, a user information system 210, and a support system 212. Different embodiments may include different combinations or subsets of these additional components.

In this embodiment, a patient data system 208 stores and updates information about one or more patients. The patient data system 208 supplies patient information to the prescription system 204. In one embodiment, the prescription system 204 stores updates to patient information (e.g., new prescriptions) in the patient data system 208. In an embodiment, a patient data system 208 shares the input system 202 with the prescription system 204. In an exemplary embodiment, the input system 202 includes a remote input system for receiving patient data from a remote system or a storage system.

In an embodiment, patient data comprises findings about a patient. Findings about a patient include one or more medical findings relating to a particular patient subject, where a medical finding is a piece of information relevant to a patient's medical condition or treatment. Medical findings may include past findings that relate to past or ongoing facts about a patient or that were entered during a previous medical encounter (e.g., demographic information, smoking status, active problems such as diabetes, past problems, current medications, allergies, family history, social history), current encounter findings relating to or entered during the current medical interaction (e.g., diagnosis, physical exam findings, chief complaint, history of present condition findings, lab results, prescribed medications), or both.

In an embodiment, a user information system 210 stores and updates information about at least one user. For example, in an embodiment the user information system 210 stores the user's name, DEA number, specialty, preferences, and medication hotlists.

In an embodiment, a support system 212 provides an external connection from the system to at least one remote server that provides maintenance functionality for the system. In one particular embodiment, a remote server periodically updates medical content stored in the system and periodically backs up patient data updated in the system.

In an electronic medical records (EMR) embodiment, the prescription system 204, user information system 210, and patient data system 208 are integrated into a single Electronic Medical Record (EMR) system with a single common user input system 202. In this embodiment, a seamless user interface provides the same look and feel to these different subsets of functionality and allows a user to quickly switch between activities (e.g., switch between review of systems (ROS) in the patient information system and prescribing a medication in the prescription system). The EMR arrangement may also provide a shared data storage system, allowing the prescription system 204 to access patient information and user information stored by the respective modules.

These subcomponents execute on one or more computers and, in one embodiment, the one or more computers are connected by one or more networks. It will be apparent to those familiar with the art that the distribution of functionality across subcomponents and the division of subcomponents across computers can take many forms without altering the nature of the system. For example, each subcomponent can run on one machine or more machines in different embodiments.

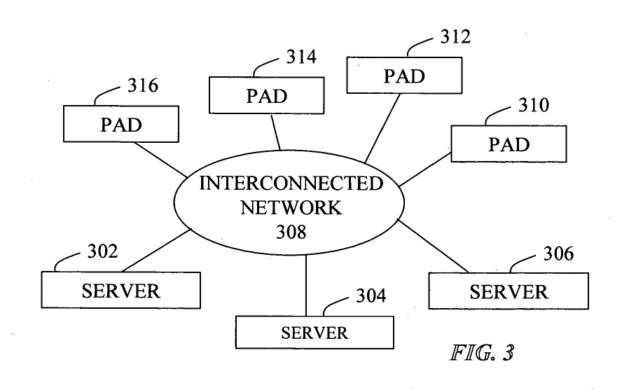

FIG. 3 depicts a system in which servers 302, 304, and 306 are connected to an interconnected network 308. Interface devices 310, 312, 314, and 316 interact with one or more of the servers 302, 304, and 306 through the interconnected network 308. The servers 302, 304, and 306 and databases associated with the servers may provide interface data to the interface devices 310, 312, 314, and 316.

The interconnected network 308 may take the form of various hard-wired and wireless networks, or combinations thereof. Further, the interconnected network may use various transfer standards and protocols, together, separate, or in various combinations, including Ethernet, wireless Ethernet, Blue Tooth®, SNMP, HTTP, FTP, SMTP, and DMI.

The servers (302, 304, and 306) may take the form of various web servers, mail servers, data servers, and computations circuitries, among others. The servers (302, 304, and 306) may be associated with databases such as those by Microsoft®, Oracle®, and others.

The interface devices (310, 312, 314, and 316) may take forms, such as laptop computers, desktop computers, handheld devices, smart devices, portable computers, web pads, tablet computers, and various computation circuitries. In one exemplary embodiment, a device for managing medical information and interfacing with healthcare providers and patients takes the form of a pad. The pad may be connected to a server or the pad may function alone accessing data from other sources. The pad may be a wireless web-enabled pad. The pad may display pages created by the server. The server and pad may communicate using various transfer protocols, languages, scripts, and security methods. For example, the pad may use HTML, Java, XML, and SSL, among others.

In this manner, the devices (310, 312, 314, and 316) act to display information that is stored and organized by the server (302, 304, and 306). If the interface device (310, 312, 314, and 316) is stolen, the data and functionality of providing prescriptions is not available to the thief. Password access also limits unauthorized access to the server (302, 304, and 306). In addition, the server (302, 304, and 306) may be updated by accessing other servers on a large network such as a global network. This way, the interface device does not require frequent updating and pharmaceutical companies may be provided access for advertising and drug studies.

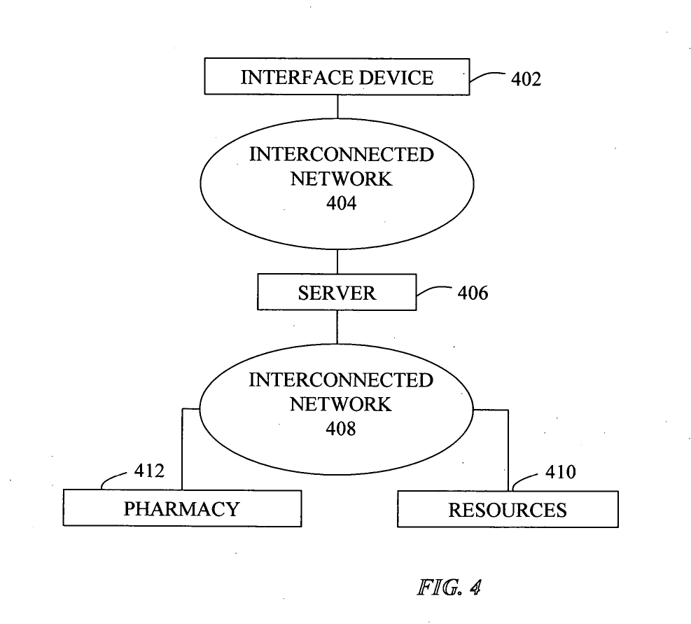

FIG. 4 depicts an alternate embodiment of the system. In this embodiment, the interface device 402 accesses the server 406 through a separate network 404. The server 406 accesses other data, pharmacies 412, and various resources 410 through a different network 408. This embodiment provides additional security to the prescription creating system while offering access and interactivity with outside resources.

In one exemplary embodiment a device 402 for managing medical information and interfacing with healthcare providers and patients takes the form of a pad. The pad may be connected to a server or the pad may function alone accessing data from other sources.

The interconnected networks, 404 and 408, may take the form of various hardwired and wireless networks or combinations thereof. Further, the interconnected networks, 404 and 408, may use various transfer standards and protocols, together, separate, or in various combinations, including Ethernet, wireless Ethernet, Blue Tooth®), SNMP, HTTP, FTP, and DMI.

In one exemplary embodiment, the pad may be a wireless web-enabled pad. The pad may display pages created by the server 406. The server 406 and pad may communicate using various transfer protocols, languages, scripts, and security methods. For example, the pad may use html, java, and SSL.

### Basic Prescribing Flows

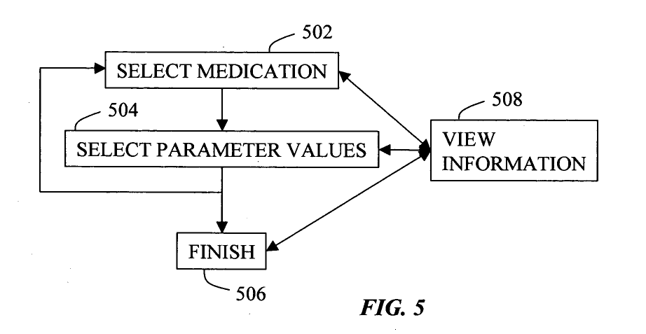

FIG. 5 is a flowchart of one embodiment of the prescription writing process. A precondition to entering this flow may be that a patient has been selected (in another embodiment, the prescription writing process includes an additional step to enter a patient's name or enter information about a patient or select a patient from a list of existing patients.) In this embodiment, a user may specify a medication, as shown at step 502, and specify parameter values for that medication's parameters, as shown at step 504. The user may repeat the process of specifying a medication 502 and parameters 504 one or more times. Finally, the user may finish the prescription writing process, as shown at step 508, which causes the system to transmit the prescription via the output system.

In one embodiment, at any step, the user may view information about the medications being prescribed, as shown at step 508. In one embodiment, the view information step 508 is a separate step wherein the user directs the system to show additional information. In another embodiment, the additional information is displayed on the same screen as the select medication, select parameter values, or finish screen without explicit invocation.

Although the prescription lists is described in terms of lists of medications, a medications list (for selecting medications or treatments) or prescriptions list (for listing the medications or treatments being prescribed for the current patient) can accommodate other forms of treatment such as counseling, schedule for follow up visit, lab order, radiology order, test order, or send information.

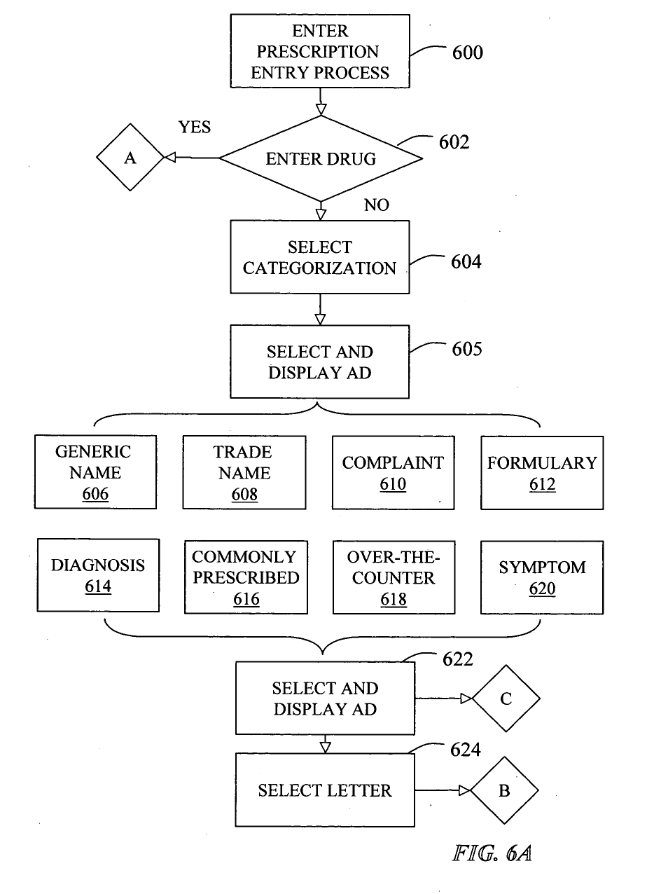

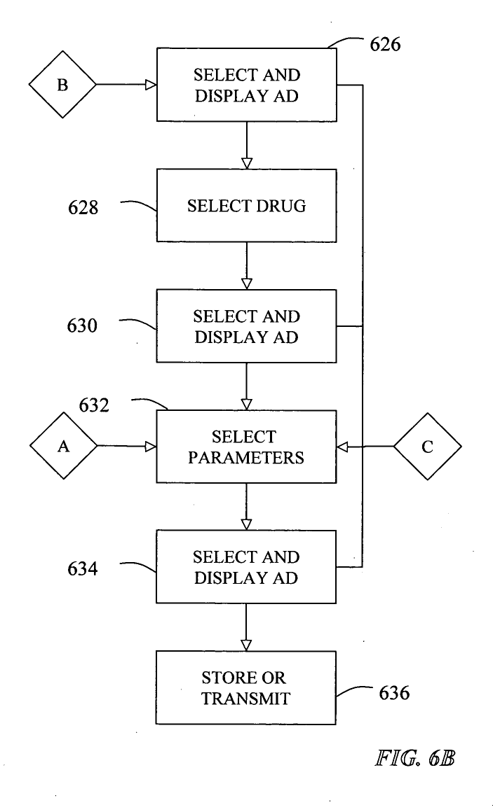

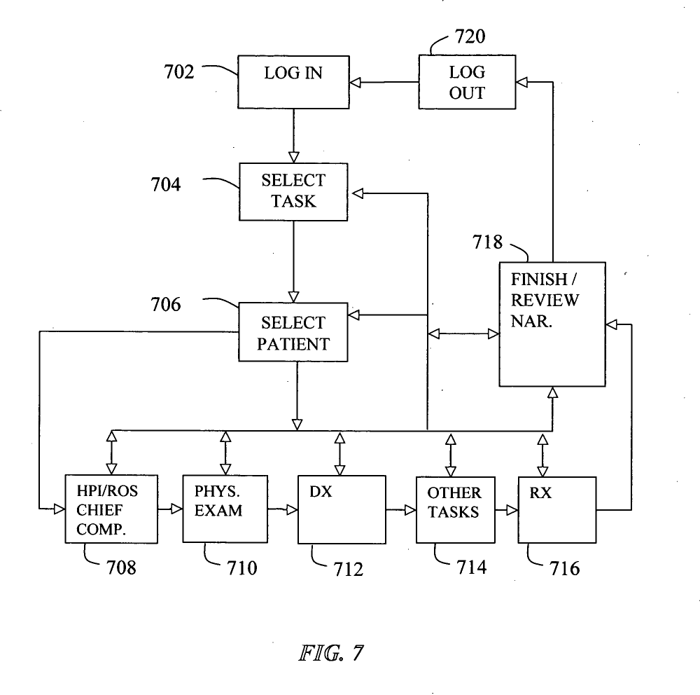

FIG. 6 is a flowchart of one embodiment of the prescription writing process. The prescription writing process allows a healthcare provider to assemble or select a prescription for the patient. In this embodiment, the healthcare worker may select a drug to be prescribed by one of several means including by entering the drug's name directly (e.g., by text or voice input), by navigating a series of menus or screens, or by selecting a currently-displayed advertisement at any point in the process. During this process the system may display healthcare and product information including one or more advertisements based on information the system has obtained about the patient, the doctor, or both. For example, the system might display an advertisement for an allergy medication when the doctor begins prescribing a medication for a patient complaining of allergies.

The healthcare worker enters the prescription entry process, as shown at step 600. If the healthcare worker chooses to enter the drug name directly, as shown at step 602, the system proceeds to display the prescribing parameters for selection, as shown at step 632. In another embodiment, for any of the selection strategies 606 through 620, the system may go directly to displaying a list of drugs step 628, skipping the alphabetical selection step 624.

If the drug name is not entered directly, as shown at step 602, the selection through navigation of menus or screens is chosen at step 604 and the healthcare worker then chooses the preferred method for selecting the prescription. The options include selecting the prescription by using the generic name 606 or trade name 608 of the drug, the patient's complaint 610, the formulary selected 612, the diagnosis for the patient's condition 614, the most commonly prescribed drugs (in general, or based on physician's prescribing history) 616, over-the-counter drugs 618, or the patient's symptom 620. If one of these options is selected (606-620), the system may then display a list of letters of the alphabet and the healthcare worker may choose one of these letters, as shown at step 624. The system displays a list of drugs from the selected category beginning with the selected letter and the healthcare worker may select one or more drugs from this list, as shown in step 624. The healthcare worker may also directly select from a list of drugs. Alternatively, if the formulary or most commonly prescribed drugs are selected, the system may directly display a list of drugs appropriate for the complaint or a list of drugs appropriate for the diagnosis, as shown at step 628. If one of these names is selected, the system proceeds to the prescribing parameters selection, as shown at step 632.

At each of these steps, the system may display one or more advertisements (605, 622, 626, 630, and 634) selected on the basis of information the system has obtained about the patient, doctor, or both in addition to information regarding the current location or step in the drug selection process. For example, the system might display an advertisement suggesting a particular blood pressure medication when a doctor is seeing a patient that is complaining of headaches enters a blood pressure that is high. At any point in the process, the healthcare worker may select a currently displayed advertisement causing the system to proceed to the select prescribing parameters step 632.

In the prescribing parameters selection step 632, the system allows the healthcare worker to select parameters for the administration of a medication such as the dosage, frequency, form, and duration. The system may also complete one or more of those prescribing parameters (dosage, form) based on information obtained about the patient such as weight, gender, current medications, and the like. In one embodiment, the system displays a form with selectable options for each parameter and initializes the selection to values likely to be appropriate for the patient based on information about the drug, information about the patient's condition (e.g., acute pain v. chronic pain), information about the patient (e.g., weight, age, gender, etc.). After selecting appropriate parameters, the healthcare provider may select options to store or transmit the prescription. During this stage, the system may display an advertisement based on information about the patient, information about the doctor, and information about the drug being prescribed. For example, the system might display an advertisement for an alternative drug that may be appropriate for the patient than the drug being considered or prescribed. The prescription is then stored to be printed out by the system or electronically transmitted to a pharmacy 636.

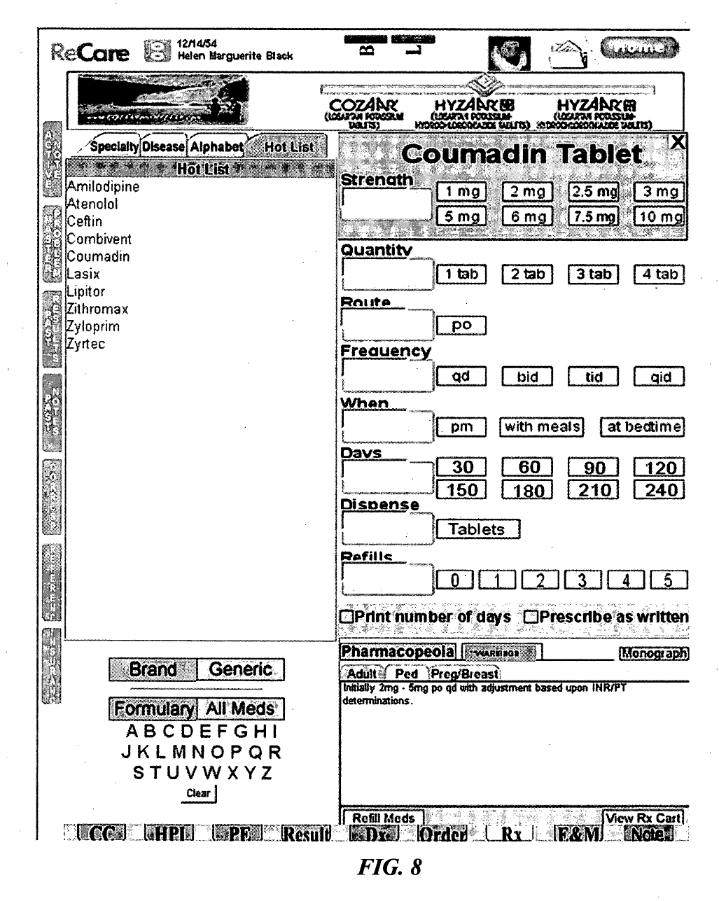

FIG. 7 is a flow chart of an exemplary EMR Embodiment where the prescription system (RX) is integrated with an EMR system that also supports patient information functionality. The EMR system includes means to log in 702 (identify user), select patient 706, and select task 704. The EMR system also includes several tasks such as HPI 708 (history of present illness), ROS 710 (review of systems), Dx 712 (enter diagnosis), and Rx 716 (enter prescription). In this embodiment, as each task is selected, the stored current task state is updated and provided to the selection means as input. The system also may also include tasks for completing a patient and preparing a narrative 718. The user may also log out 720.

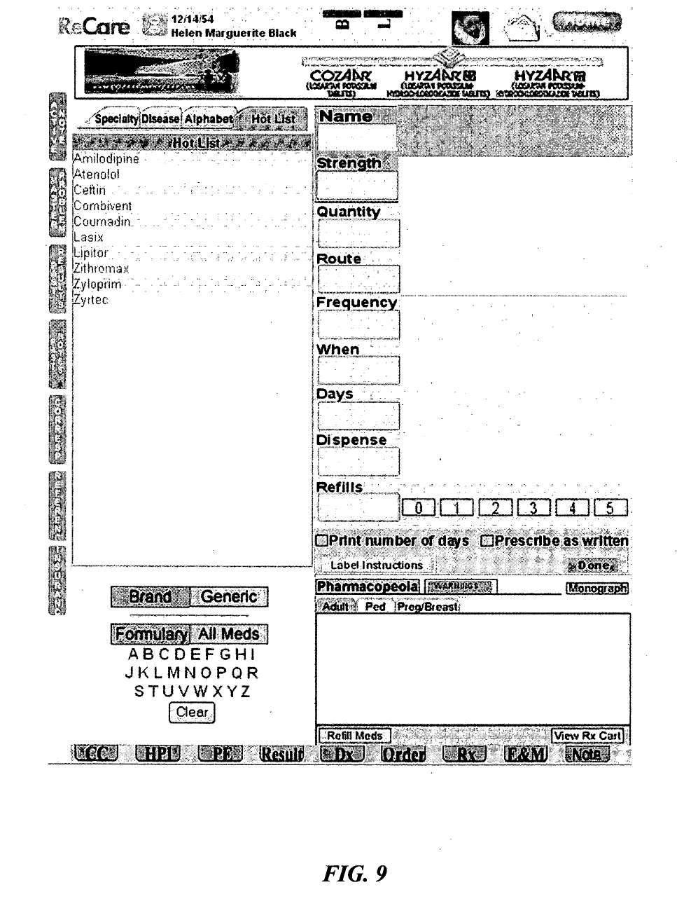

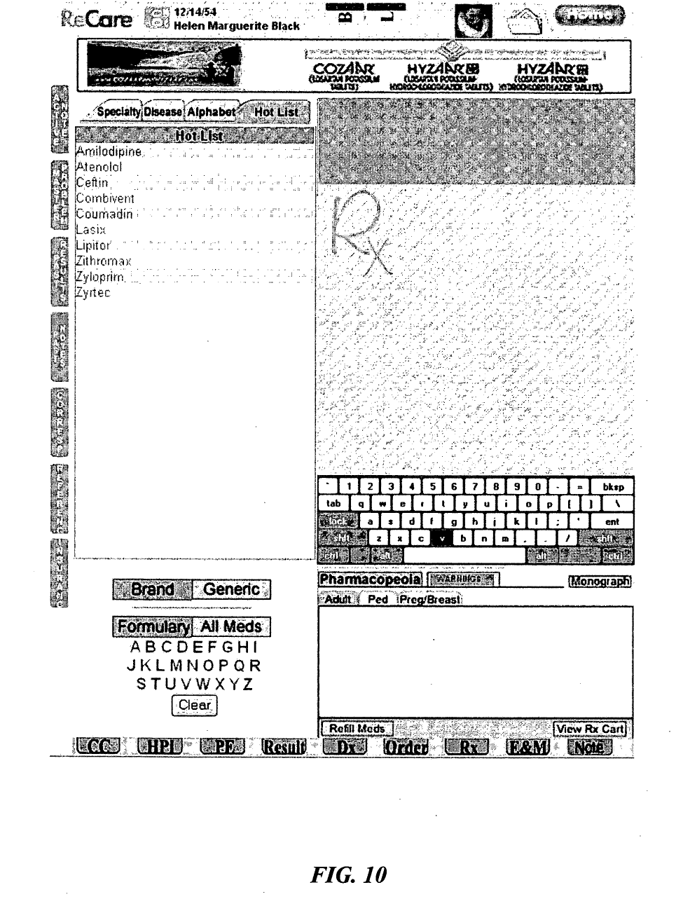

FIG. 8 depicts a discrete input method for entering prescriptions. In this method, a medication is selected from a list of medications and prescribing parameter values are selected from a list of values. FIGS. 9 and 10 depict alternate methods for entering prescriptions. FIG. 9 depicts the use of text boxes. In one exemplary embodiment, these text boxes may be populated using an electronic writing implement. FIG. 10 depicts the use of a script pad or writing pad, which may be implemented with a homunculus or electronic writing implement. One or more of these methods may be presented to a user in a single screen of an interface or provided as options accessible through separate pages of an interface.

### Further Embodiments Enhancing “Selecting Medication”

As described in the discussion pertaining to FIG. 5, a prescribing system embodiment includes a selecting medication step in which one or more medications are selected for prescribing.

In one embodiment, different lists of medication are statically generated, for example as a set of linked HTML pages showing different medications and providing links to other lists.

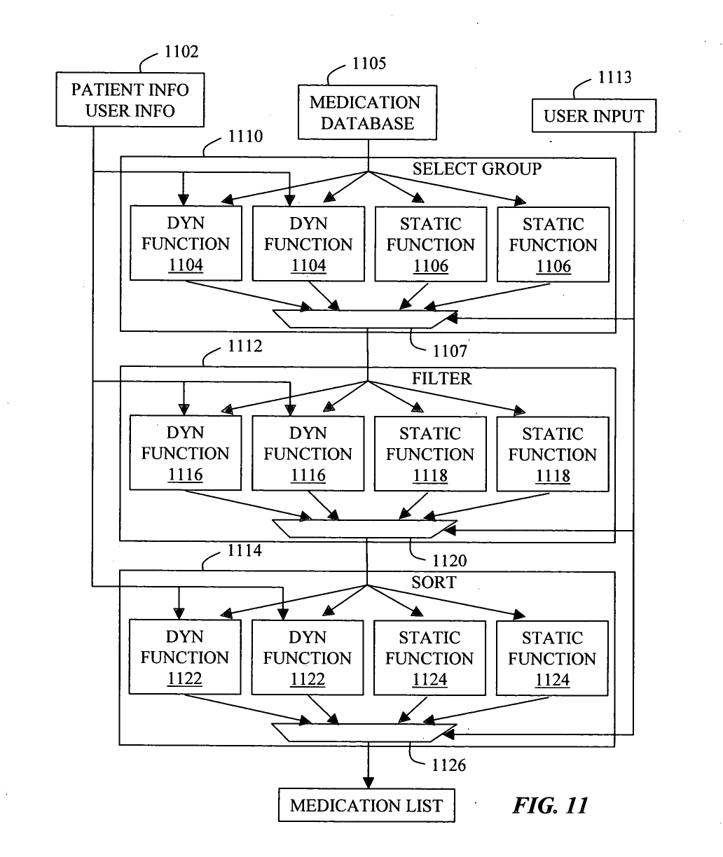

In another embodiment, FIG. 11 depicts a data flow for an exemplary medication selection subsystem. In this embodiment, the prescribing system includes a medications database 1105 on which a select group function 1110 operates to select a subset of medications 1107. In this embodiment, a selected subset is processed by a filter function 1112 that deletes elements from the subset. Then, the filtered subset 1120 is sorted by a sort function 1114 to order the elements 1126 for display.

In an embodiment, the select group 1110, filter 1112, and sort 1114 modules each respectively, may include multiple selection or filter or sort functions, and these functions include static functions (1106, 1118, and 1124) that take a medication list as input and dynamic functions (1104, 1116, 1122) that take medication lists and at least one of patient information (see FIG. 2), user information (see FIG. 2), or user input (see FIG. 1 or FIG. 2) as inputs. Furthermore, in this embodiment, user input 1113 provides a means for selecting which functions to activate.

Static selection functions (1106, 1118, 1124) define pre-specified subsets of medications (e.g., medications whose generic (or trade) name begins with the a particular letter such as the letter M, medications belonging to a particular class such as anti-tussives or anti-microbials, medications relating to a particular specialty such as pediatrics or oncology, or medications associated with a particular diagnosis such as medications associated with lacerated arm.) Static filter functions (1106, 1118, 1124) define pre-specified attributes of medications on which to filter against pre-specified values (e.g., medication form such as “filter out medications that are in tablet form” or “filter out medications except those available in liquid or suppository form,” medication formulary such as “filter out medications except those present on the Blue Cross formulary for plan UT1102,” availability of generics such as “filter out medications that are not available as generics.”) Static sort functions (1106, 1118, 1124) define pre-specified attributes of medications on which to sort (e.g., sort alphabetically, sort by category, or sort by price.)

Dynamic selection functions (1104, 1116, and 1122) select subsets of medications based on both the list of medications and information about the patient or information about the user. For example, a “hot list” function may select the subset of medications that are flagged in the user's hot list of medications; a “recent medications” function may select the subset of medications that have recently been prescribed by the user; a “select-by-diagnosis” function may select the medications that are relevant to the diagnosis currently associated with the patient; a “select-by-refills” function may select medications the patient is currently or recently taking in order to streamline the refill process for the user, and a “select-by-formulary” function may select the medications that are associated with the formulary that is associated with the patient. Dynamic filter functions (1104, 1116, and 1122) select subsets of medications based on both the list of medications and information about the patient or information about the user. For example, a “filter-by-patient-formulary” function filters out medications that are not on the patient's formulary; a “filter-by-allergy” function filters out medications that the patient is allergic to; and a “filter-by-contraindication” function filters out medications that are contra-indicated given the patient's condition or demographic information. Dynamic sort functions (1104, 1116, and 1122) sort subsets of medications based on both the list of medications and information about the patient or information about the user. For example, a “sort-by-cost” function sorts medications based on their base cost and their presence/absence on the formulary of the payer associated with the patient.

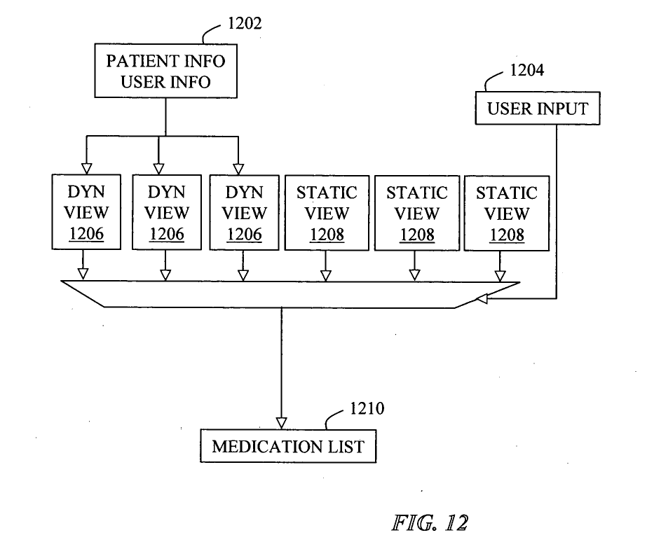

FIG. 12 illustrates another embodiment in which user input and navigation selects a view of the medications list 1210. In this embodiment, different views are generated in different ways. If the user selects 1204 a static view 1208, the system displays a list of medications that depends on the view selected but not on patient information or user information 1202. If the use selects 1204 a dynamic view 1206, the system displays a list of medications that depends on at least one of patient information or user information 1202. Different dynamic views 1206 may be implemented in various ways such as an arrangement of selections, filters, and sort functions as described with regards to FIG. 11 or such as a static list of medications that is filtered according to some set of Boolean rules.

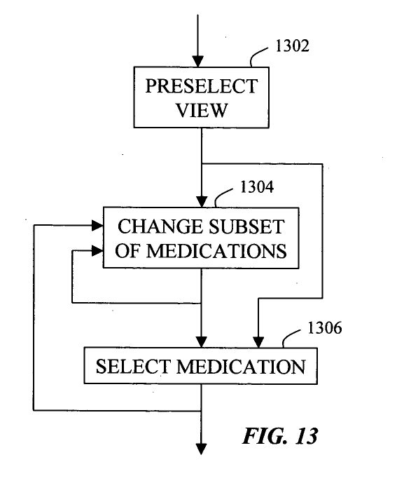

FIG. 13 is a flow chart of an embodiment of a select-medication module. When a select-medication screen or subscreen is first shown, a preselect-view function 1302 decides which subset of medications to display. In an embodiment, the preselect-view function, as shown at step 1302, chooses an initial select function, filter function, and sort function. The user may then change the subset of medications to display, as shown at step 1304. In an embodiment, the user selects different tabs or buttons on a display that each correspond to a different combination of select function, filter function, and sort function. In an embodiment, the user may also enter text (e.g., by typing, speaking, or handwriting) to change the subset of medications to display (e.g., the display may jump to the listed item whose name begins with the letters just entered.) In an embodiment, the user may repeatedly execute the change subset of medications function. The user may select a medication, as shown at step 1306. In an embodiment, selecting a medication is done by touching a displayed medication or by entering a medication name letter by letter. In one embodiment, selecting a medication causes the select-medications subsystem to become inactive and a select parameters subsystem to become active. In another embodiment, the select medication system remains active after a medication is selected. In this embodiment, selecting a medication adds the medication to the prescribed list of medications for the patient and displays the updated list of prescribed medications for the patient on one portion of the screen, but the system continues to display the select medication functionality in another portion of the screen.

In one embodiment, the pre-select view function selects a related-medications view that contains medications related to the patient's diagnosis.

### Electronic Prescription Pad Embodiments

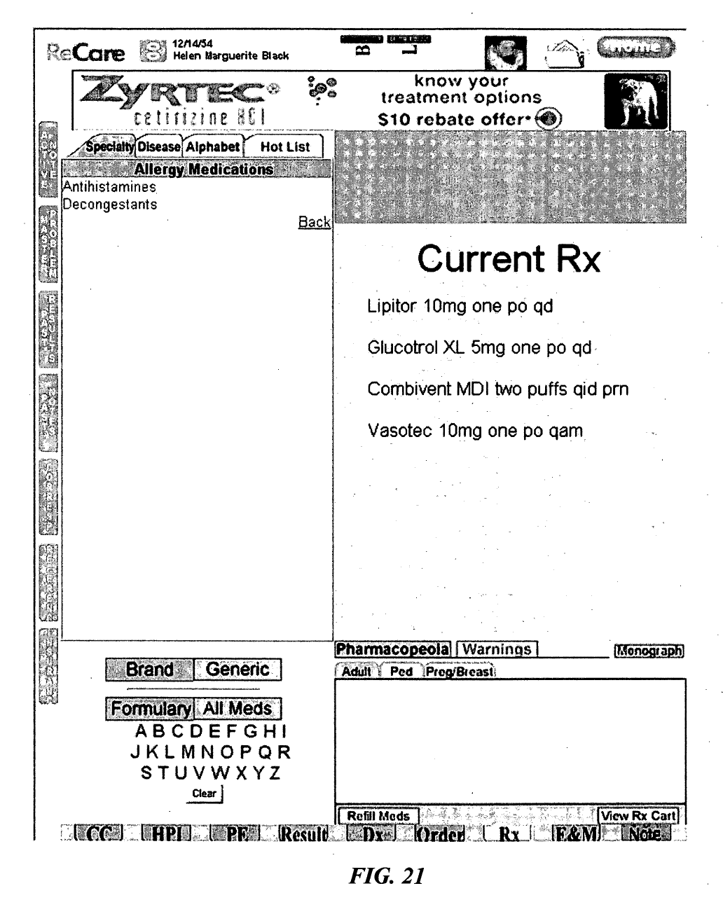

FIGS. 8, 9, 10, 14-27, 29-32, 34-38, 41, 43-45, and 47-50 depict exemplary embodiments and interfaces for a prescription pad. In FIG. 7, the interface may be seen to have advertisements near the top of the screen for Covaar and other pharmaceuticals. The left of the screen contains sets of tabs and links. Near the bottom of the left is a section of alphabetic access to options. The right of the screen contains a further set of tabs and, in this embodiment of the screen a listing of current medications for a given patient. The bottom right of the screen contains a message panel for displaying pharmacopoeia and warning information.

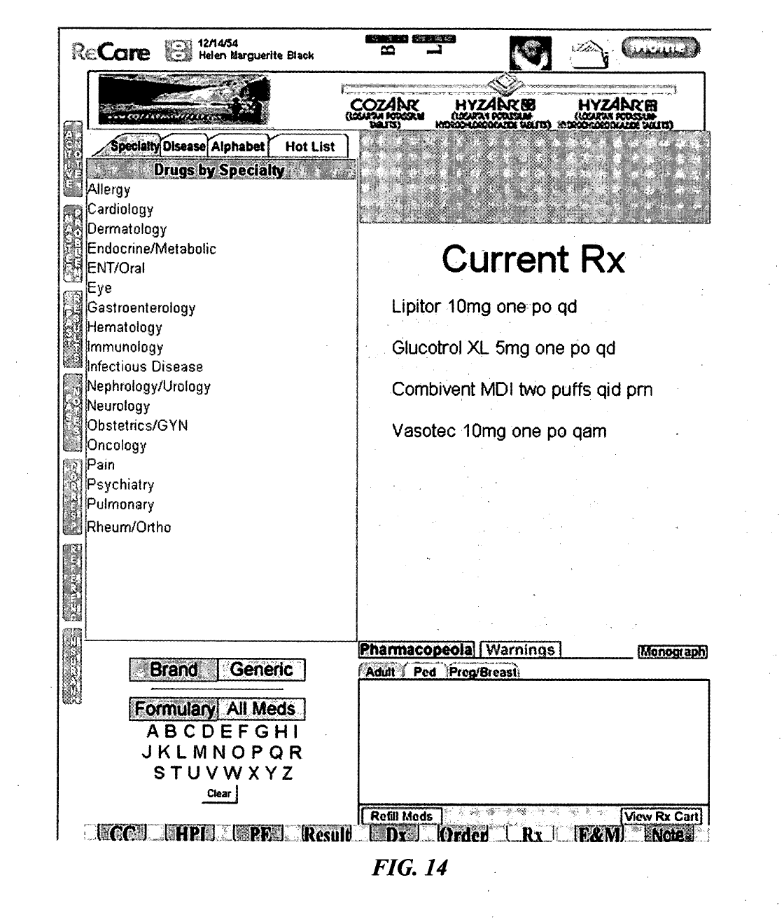

When accessing the prescription pad system and in preparing a prescription, a doctor or medical professional has access to various methods for finding a desired medication, access to information regarding the medication and the patient, and access to advertising and suggestions. A search for a pharmaceutical agent may be performed by selecting one of the tabs: specialty, disease, alphabet, or hot list. FIG. 14 depicts the specialty tab through which a medical professional has access to medications through links organized by specialty such as allergy, cardiology, and dermatology, among others.

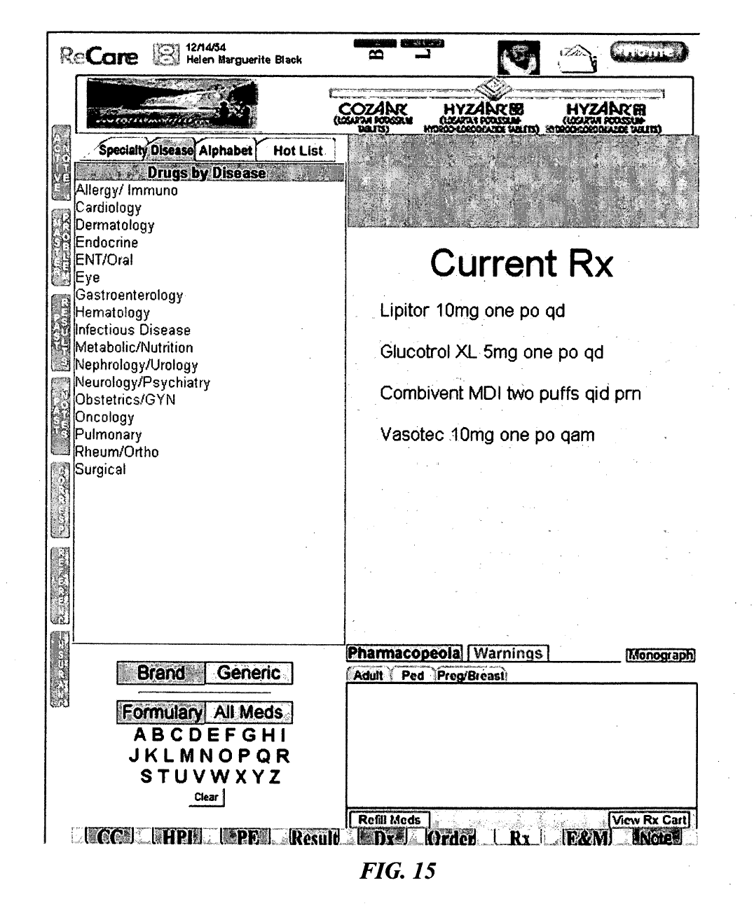

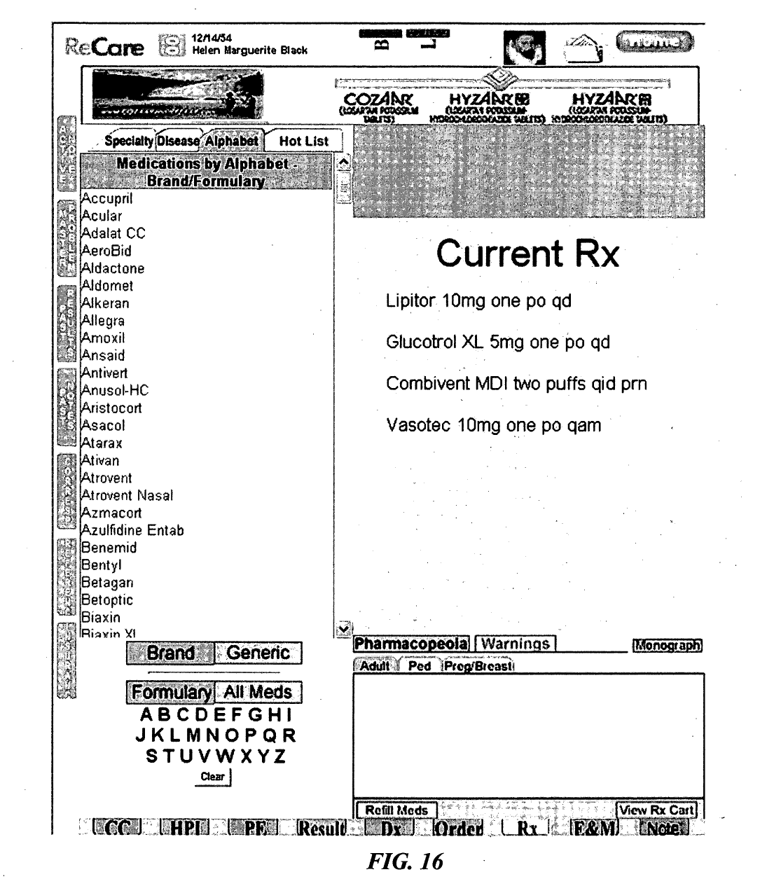

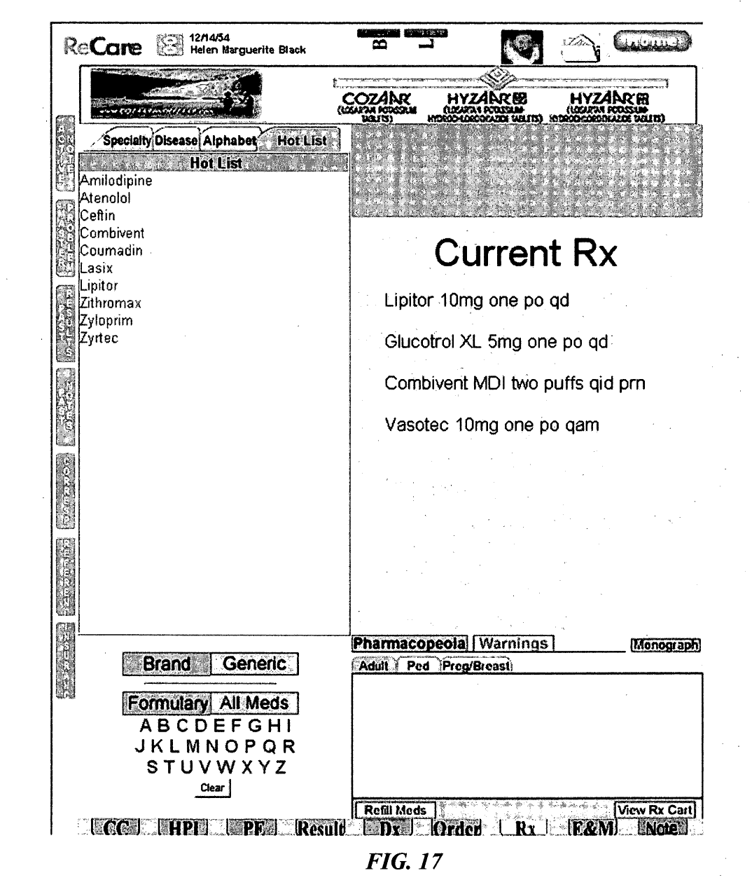

FIG. 15 depicts access through a list of links organized by disease. The list may contain links such as infectious diseases and metabolism, among others. FIG. 16 depicts alphabetic access. A medical professional may scroll through the list, click on a first letter of the pharmaceutical agent, or tab through the list to select the desired medication. Similarly, FIG. 17 depicts an organization through a “hot list.” The “hot list” may contain commonly or frequently prescribed medications. For example, a general practice physician may prescribe a medication for an infection that is frequently seen over a given period. The “hot list” provides quick and easy access. In another example, a specialist such as an allergist may typically prescribe a limited number of medications. As such, a “hot list” would provide easy access to those medications.

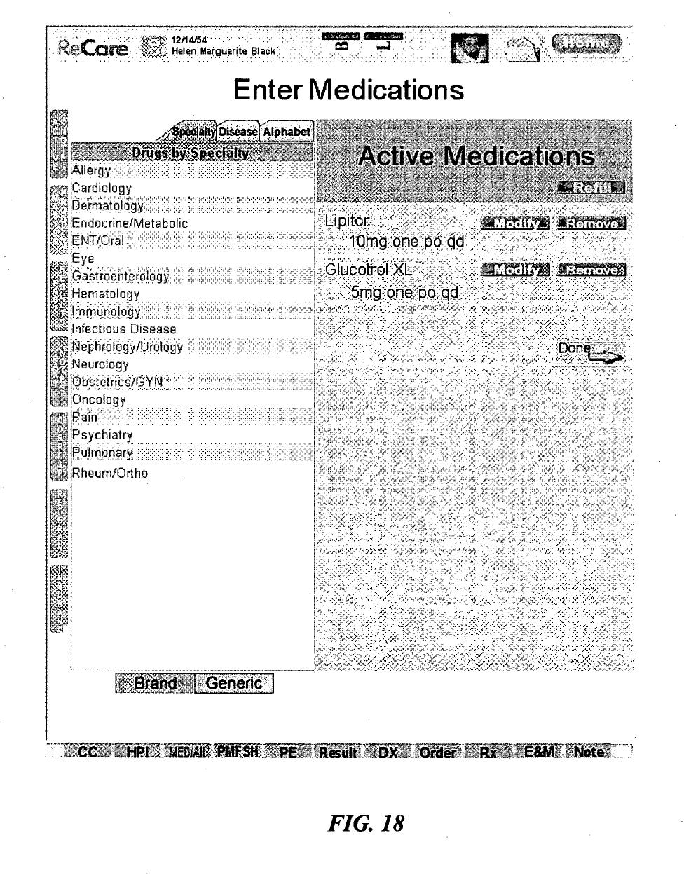

Through the listing of current medications or a tab set seen herein on the left of the screen, the system may also permit easy access for prescription adjustment or refilling, as seen in FIG. 18. Medical professionals may access current prescriptions and easy alter them as desired. This feature is especially important when a refill is requested through a pharmacy or a patient describes difficulty with a specific prescription or dosage.

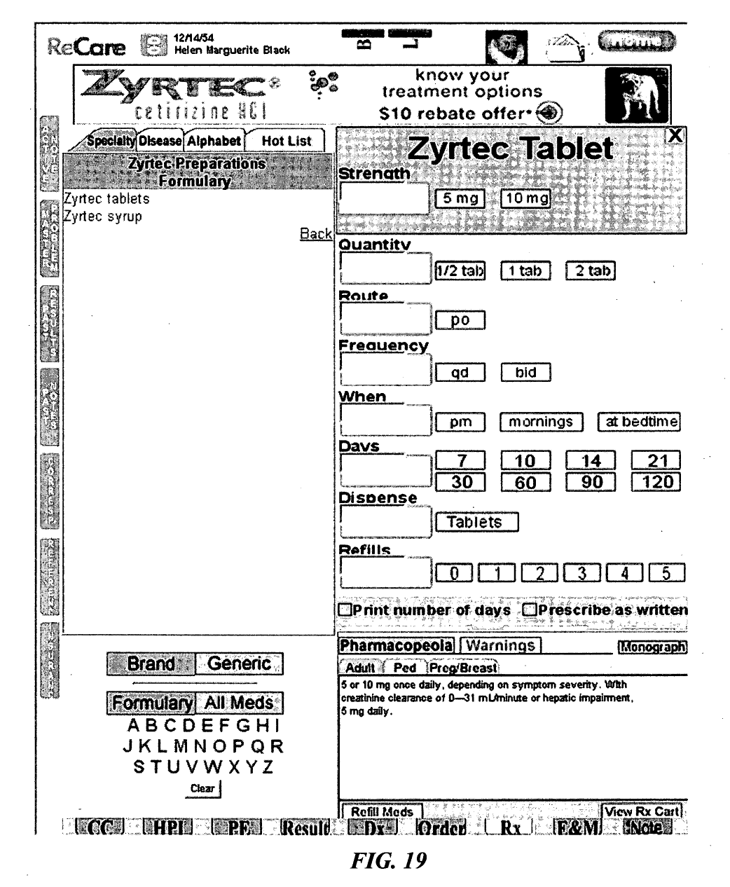

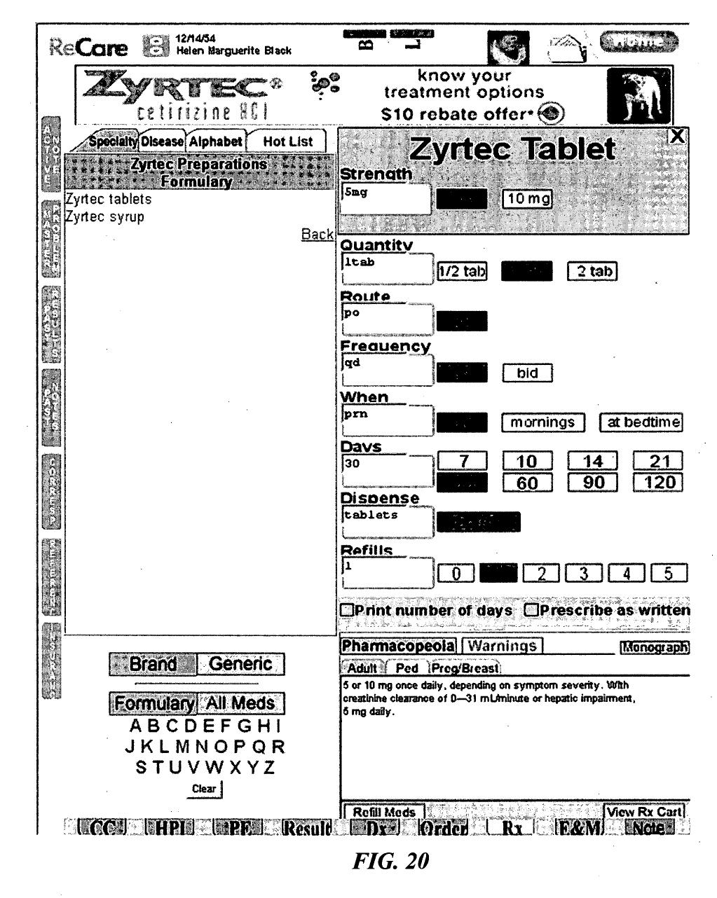

FIGS. 19 and 20 depict the prescription form without and with selected prescription data. The prescription may then be sent to the output system which in an embodiment allows the prescription to be sent to a printer or facsimile machine, forwarded through an electronic prescription system, and/or stored for use in another manner.

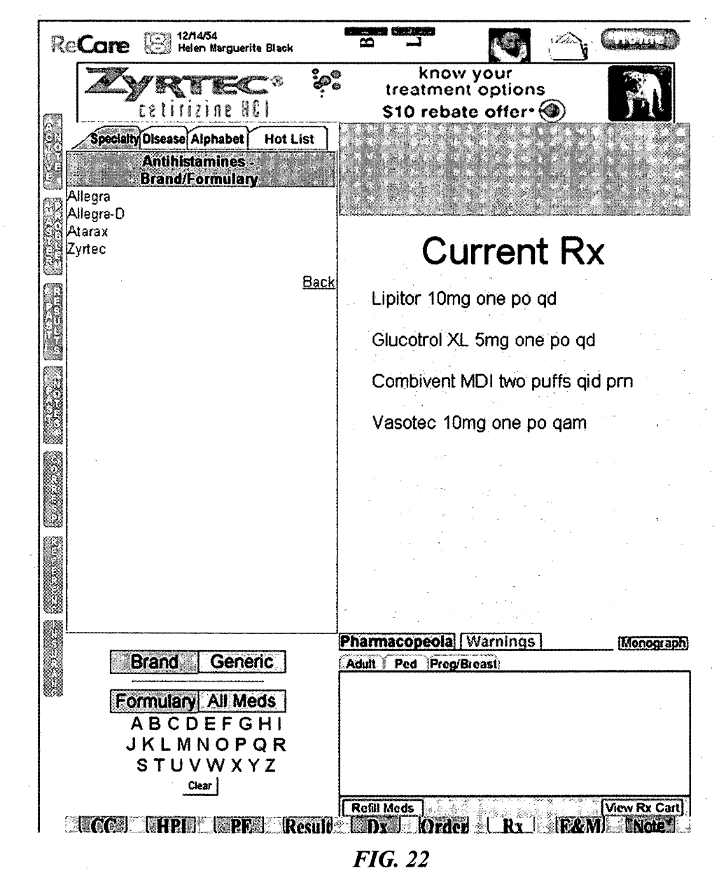

Turning back to the selection process of a medication for prescription as seen in FIGS. 14, 15, 16, and 17, FIG. 21 depicts the selection of a specialty category, allergy. Medications associated with the treatment of allergies may then be displayed. In this exemplary embodiment, the system may display antihistamines and decongestants. These subcategories may then be selected to display available medications as seen in FIG. 22. From this screen a specific medication may be selected to access a prescription entry screen.

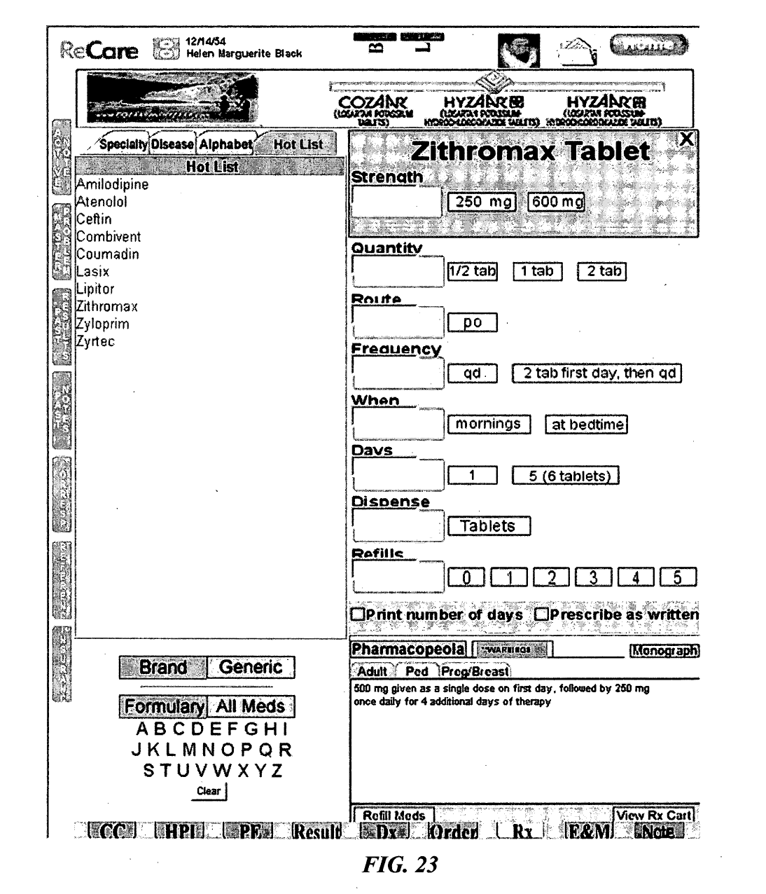

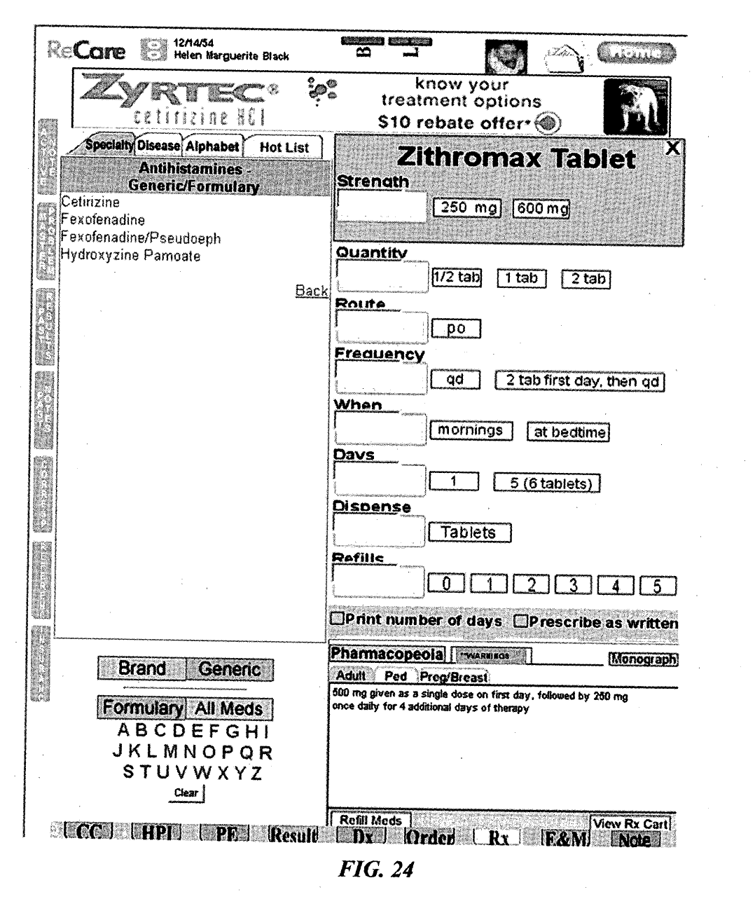

The prescription entry screen may also be accessed through the “hot list” as seen in FIG. 23. In this exemplary embodiment, Zythromax is selected from the “hot list” to provide a prescription entry form. In addition, the advertisement may change as seen in FIG. 24 to suggest an alternative or complementary medication.

At the lower left of the screen are buttons for generic and brand. These buttons may be used to access brand name or generic listings. FIG. 24 depicts the selection of the generic button in search of a generic antihistamine. The generic and brand buttons may also be used to display the various names of a given medication.

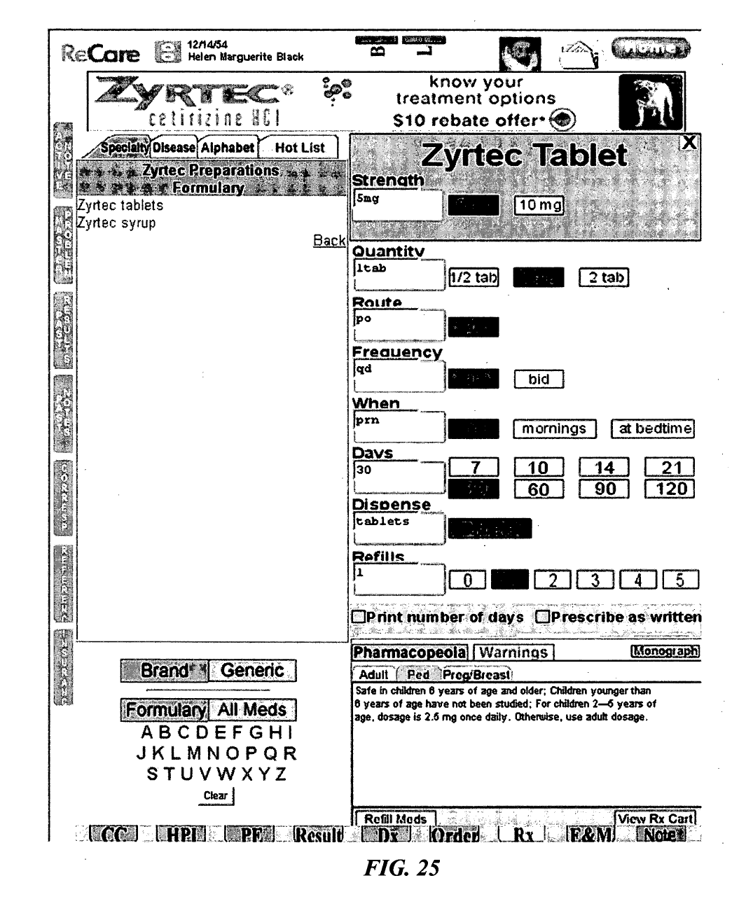

FIG. 25 depicts the selection of formularies. In this example, Zyrtec may be prescribed as a syrup or tablet. Selection of the formulary adjusts the prescription entry form to permit prescription with the appropriate parameters.

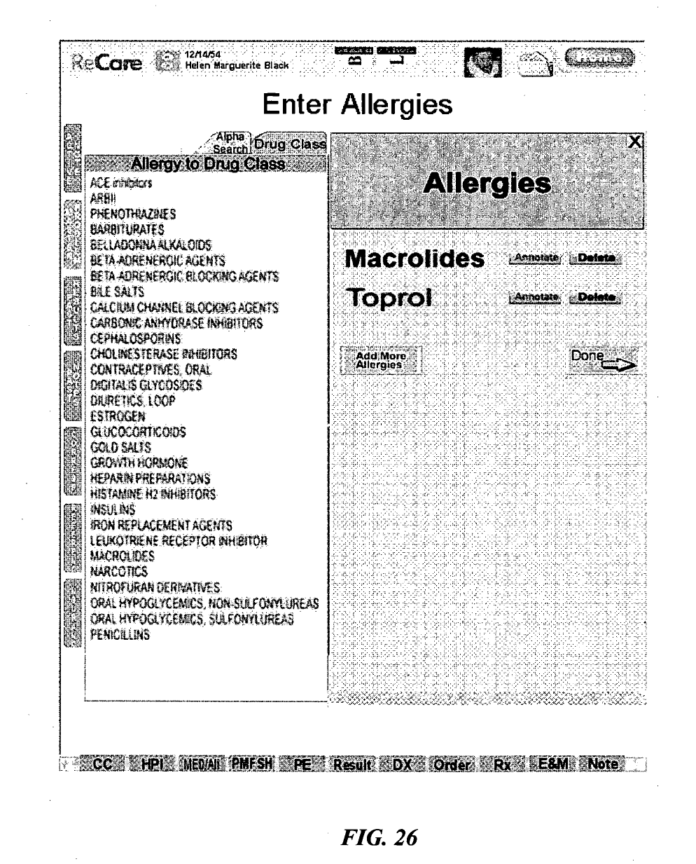

FIG. 26 depicts an alternate method of accessing medications for specifying allergies to medications. In this example, the system depicts selection by alphabet.

Once a medication or pharmaceutical agent is selected, the system allows a user to enter the dosage and other parameter values as seen in FIG. 19. This prescription data may be selected from drop down menus, checkboxes, radio buttons, text boxes, and other methods. For example, the available strengths of a given medication may be automatically displayed for selection. In addition, suggested guidelines for a prescription may be made available for selection. In the message box, information about pharmacopoeia may be displayed such as suggested doses for adults, pregnant women, or children. The message box may also display warnings such as interactions with other medications prescribed to the patient or known side effects and allergies.

A display advertisement may also be seen at the top of the screen. Such an advertisement may be used to inform a doctor of an alternative medication or provide a link to more information about related medications. For example, the advertisement may inform a doctor about a new formulary or rebate information.

### Further Embodiments Enhancing “Selecting Parameters”

### Automatic Parameter Embodiment

In an automatic parameter embodiment, at least one medication is associated with at least one parameter value. If a parameter value is associated with a medication, then if that medication is selected, the parameter value is selected as the initial or default value for that parameter without requiring specific per-parameter action by the user. In an embodiment, such a value is an initial or default value, but the user may manually change this value to a different value after the parameter values for the medication are initially displayed.

In a static automatic parameters embodiment, parameter values are associated with specific medications and are not a function of patient information. Thus, whenever a medication is selected, the same set of initial parameter values are selected.

In a variable static automatic parameters embodiment, parameter values are associated with specific medications and the screen or list from which the medication is selected, but are not a function of patient information. Thus, the initial parameters associated with a medication may be different depending on how the user selects the medication. For example, in an embodiment, if the user selects penicillin from the “hot list” or from a list of medications associated with the disease “pharyngitis”, initial parameter values describing a 10-day course of 500 mg tablets taken four times per day are selected, but if the user selects penicillin from an alphabetical list of medications or from a list of anti-microbials, no initial parameter values are selected.

In a dynamic automatic parameters embodiment, parameter values are associated with specific medications are a function of patient information. Thus, when a medication is selected, it may have different initial parameter values depending on information about the patient being treated including past medical information (e.g., demographics, age, weight, gender, allergies, pregnancy status) or current encounter information (e.g., diagnosis, chief complaint, other symptoms, lab results). For example, in an embodiment, the system incorporates different dosages for medications depending on the age (pediatric v. adult v. geriatric) and weight of a patient.

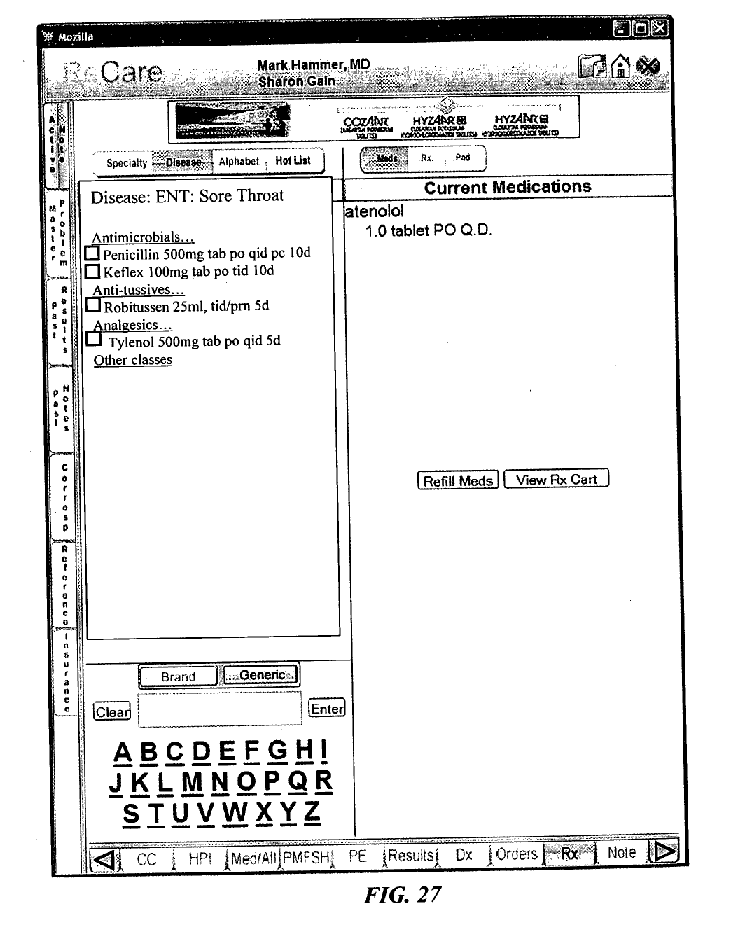

In a displayed automatic parameter embodiment, when displaying a medication with which one or more parameter values are associated, the system displays the associated parameter values. FIG. 27 depicts an embodiment of a displayed automatic parameter system where a set of medications with their default prescribing parameters are listed. Note that a displayed automatic parameter system may be a static, variable static, or dynamic system.

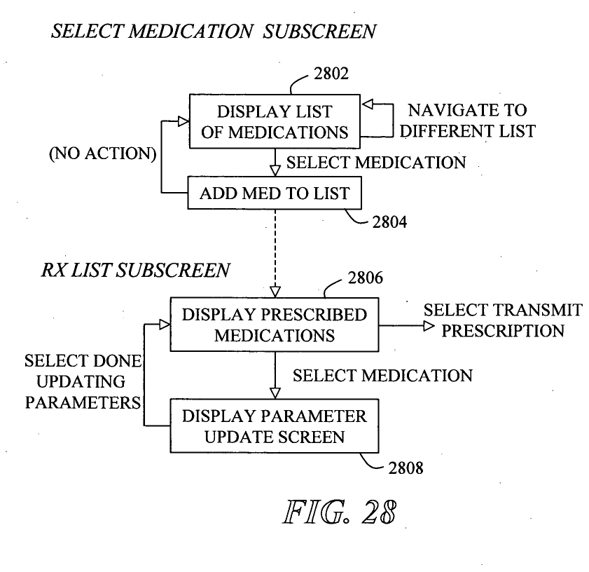

FIG. 28 depicts a flow chart for an embodiment of an automatic parameter system. In this embodiment, two subscreens are simultaneously displayed to the user, and the two flow charts show the actions that a user can take as labels on the lines between states/actions of the system (which are shown as labeled boxes.) The flow relating to the select medications screen first displays a list of medications, as shown at step 2802. A user may then navigate to a different list, which causes the system to display the new list, as shown at step 2802. Or, the user can select a medication from the displayed list, which causes the system to add a medication to the Rx list, as shown at step 2804. The system continues to display a list of medications, allowing the user to select additional medications by navigating to them and selecting them. The flow relating to the Rx list subscreen continuously displays prescribed medications, as shown at step 2806. When the user adds medication to Rx list from the select medication subscreen, the Rx list subscreen automatically updates the display of the prescribed medications to include the newly selected medication. When the user adds medication to Rx list from the select medication subscreen, the medication is associated with initial parameter values and these parameter values are displayed on the prescribed medications subscreen. A user may edit the current parameter values of a medication by selecting a medication, which causes the system to display a parameter update screen, as shown at step 2808, that displays the current parameter values and also provides a means such as on-screen buttons or text input boxes to update the parameter values. When the user is done updating the parameter values, she may select done updating parameters causing the system to display a prescribed medications list with the updated parameter values. At any point, the user may transmit a prescription, which causes the system to exit the prescribing process. In an embodiment, the system stores the current set of prescriptions and sends the prescriptions to the output system when the user indicates that the encounter is complete.

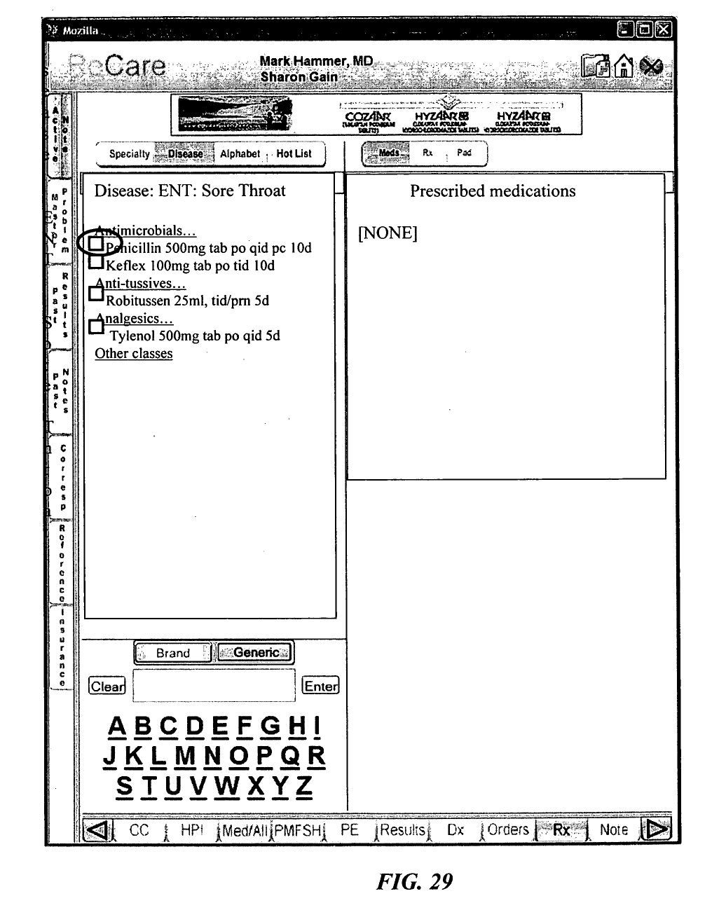

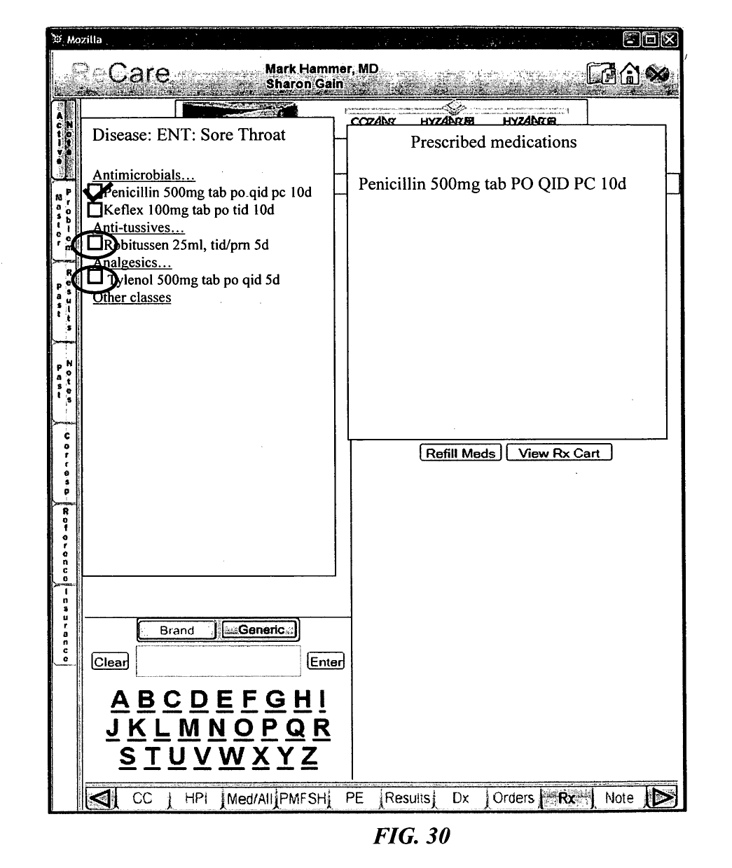

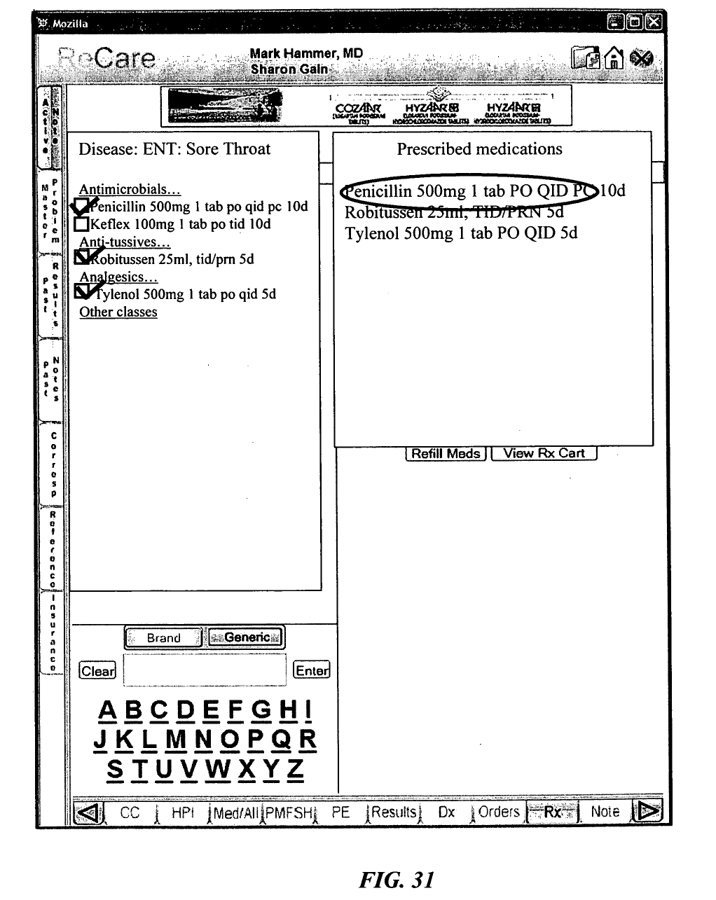

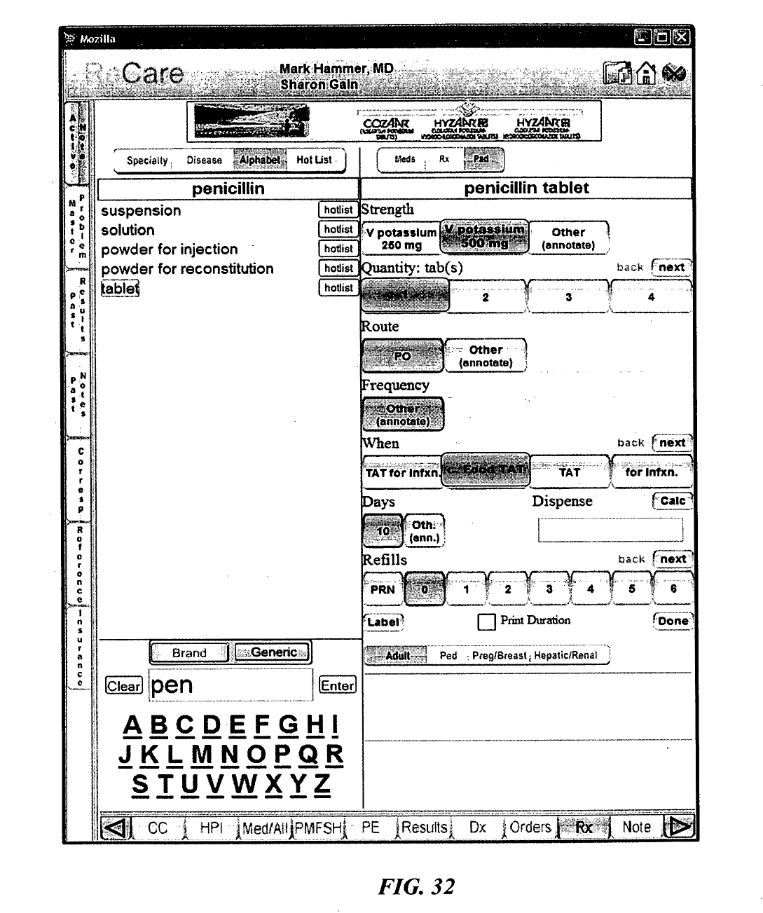

FIGS. 29, 30, 31, and 32 illustrate an embodiment of a user interface for a system that functions as described in FIG. 28. In FIG. 29, the user selects a medication from a list, which causes the system to add the list to the prescribed medications list and display it as illustrated in FIG. 30. Similarly, if the user selects the circled items in FIG. 30, such as, for example, by circling or touching the box associated with the item or the item itself, the medications are added to the prescribed medications list as illustrated in FIG. 31. If a user selects a medication on the prescribed medications list such as the circled item in FIG. 31, the system provides a parameters select screen for changing the parameter values of that medication. One such screen is illustrated in FIG. 32.

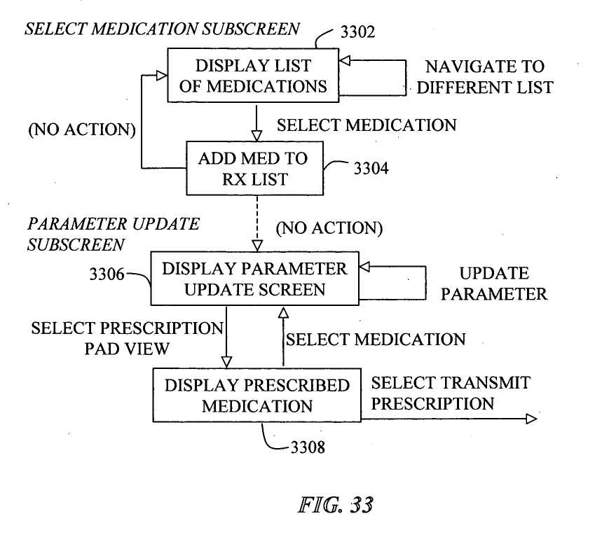

FIG. 33 depicts a flow chart for an embodiment of an automatic parameter system. In this embodiment, two subscreens are simultaneously displayed to the user. The flow associated with the select medication subscreen first displays a list of medications, as shown at step 3302. A user may navigate to a different list, which causes the system to display the new list. Or, the user can select a medication from the displayed list, which causes the system to add a medication to the Rx list, as shown in step 3304, and in the other subscreen to display the select parameters screen, as shown in step 3306, for the selected medication using the initial parameter values for the medication. The user may the update parameter values for the medication in the parameter update subscreen. In the parameter update subscreen, the user may toggle between a parameter update view and a prescription pad view, which displays the list of medications that have been selected so far. In one embodiment, selecting a medication on the select medications subscreen or the pad view of the parameter update subscreen causes the system to display the parameter updates subscreen. Conversely, selecting “pad view” causes the system to display the pad view in that subscreen. In this embodiment, from the pad view, the user may select transmit prescription, which causes the system to exit the prescribing process. In an exemplary embodiment, the system stores the current set of prescriptions and sends the prescriptions to the output system when the user indicates that the encounter is complete.

In one embodiment of an automatic parameters system, a set of HTML pages define several lists of medications that can be navigated by a user and such that selecting a medication causes the system to display a “select parameter values” screen or subscreen on which a user can specify parameter values. Functionality may be similar to “shopping cart” systems used in e-commerce where several different medications can be prescribed and parameters selected, and then finally the entire prescription confirmed and sent to the output system. In an embodiment, the HTML pages that list medications also have embedded in them initial parameter values for the medication. In one static or variable static embodiment, static HTML pages are generated and displayed, with the same pages used regardless of patient information. In one dynamic embodiment, the pages are dynamically generated by a server just before display so that different initial parameter values can be included on the page to account for information about the patient. A subset medications may not have associated default parameter values—if such a medication is selected, the select parameters screen is displayed with no initial default parameters selected. A medication may have default parameter values for some parameters but not others. If such a medication is selected, the select parameters screen is displayed with some parameter values initially selected and others unselected.

### Taper Embodiment

In a taper embodiment, a series of parameter values that vary over time may be entered into a prescription. In one embodiment, after a medication is selected, the user updates the prescribing parameter values for the medication. The user selects the taper function and is given options to control the change in parameter values over time.

In one embodiment, the user selects an initial dosage and frequency and then selects an increment or decrement value for each. The user also selects a period and, optionally, a duration. In this embodiment, the dosage and frequency increase/decrease by the specified amount each period until either reaches zero or the duration is reached. For example, if the initial dosage is 1000 mg, initial frequency is 2/day, period is 1 week, dosage decrement value is 250 mg, and frequency decrement value is 0, the patient will be prescribed 1000 mg 2/day for week 1, 750 mg 2/day for week 2, 500 mg 2/day for week 3, and 250 mg 2/day for week 4. In an embodiment, after calculating these tapered parameter values, the system displays the series to the user for verification. Other embodiments allow tapering of other parameter values, not just dosage and frequency.

In one embodiment, the user is given a series of sets of fields in which each set corresponds to the parameter values for a period of time and where the system allows specification of that period of time. For example, when the user selects the taper function for a medication, the system displays three rows of text input boxes labeled “dosage”, “frequency (‘per day’)”, and “duration (days)”. Each column then represents a taper interval of some duration that may be specified in the bottom (“duration”) row of boxes; during that interval, the dosage and frequency from that column will apply.

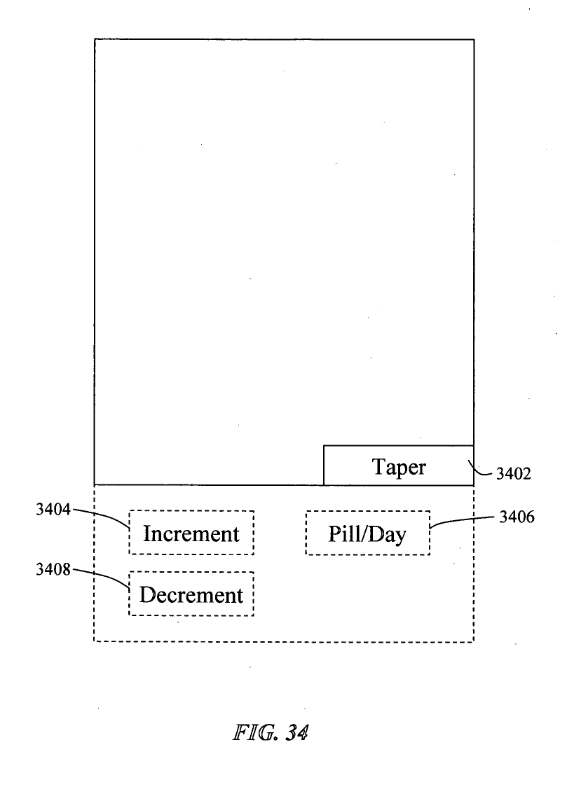

FIG. 34 depicts a taper button that may be provided on the prescription entry pages or other pages. The taper button 3402 would permit complex prescriptions to be entered such as incrementing or decrementing doses. Once the taper button is selected, a prescription entry pad may adapt to permit entry of doses. Alternately, buttons such as increment 3404, decrement 3408, or pill/day options 3406 may appear. However, various means may be envisioned.

### Further Embodiments Enhancing “Display Information”

In one embodiment, the system displays information associated with a medication. In an embodiment, this information includes at least one of a prescribing abstract for the medication, contra-indications for a medication, warnings about the medication, research reports regarding the medication, information regarding a competing or alternative medication, information regarding a complementary medication.

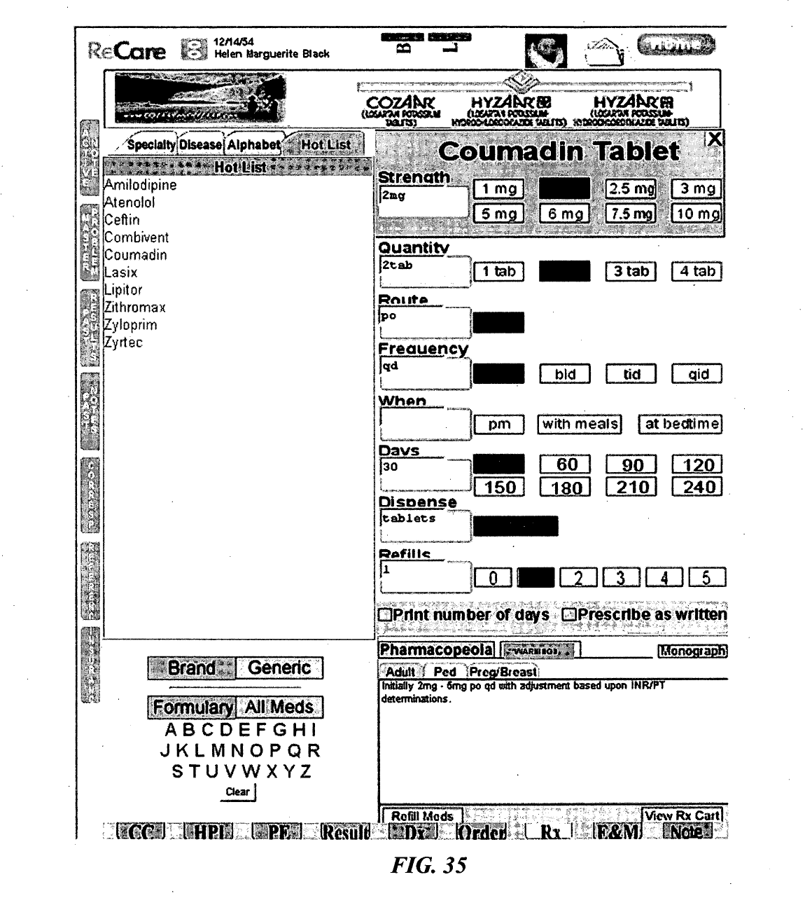

In an embodiment, the information that the system selects for display is a function of the currently selected medication. For example, when a select parameter values screen is displayed for a medication, one embodiment displays reference information for that medication in a subscreen. FIG. 35 depicts a user interface for one such system.

In an embodiment, the information that the system selects for display is a function of the list of medications currently displayed. For example, when the system displays a list of anti-microbials that allows the user to select a medication from the list for prescribing, the system displays data relevant to choosing from among the different options. For example, in one embodiment, this data is an advertisement for one of the medications. For example, in one embodiment, this data is a reminder from a managed care unit that drug X has recently become available as a generic.

In an embodiment, the information that the system selects for display is a function of the medication that is displayed and of the information about the patient. For example, when a select parameter values screen is displayed for a medication, one embodiment displays any warnings our contra-indications for that medication for the current patient based on factors including the patient's age, pregnancy status, allergies, or other currently-prescribed medications (e.g., drug interactions.) For example, when a select parameter values screen is displayed for a medication, one embodiment displays a warning and an alternative medication if the selected medication does not appear on the patient's payor's formulary.

In an embodiment, the information that the system selects for display is a function of the list of medications currently displayed and of the information about the patient.

In an embodiment, the information that the system selects for display is a function of information about the patient. For example, if the patient has been diagnosed with a cough, in one embodiment, the system displays information about medications relating to coughs.

In an automatic selection embodiment, the information displayed is associated with at least one medication such that selecting the displayed information causes the associated medication(s) to be added to the prescription list for the current patient.

In an automatic selection and automatic parameter value embodiment, the information displayed is associated with at least one medication and at least one associated medication is associated with a set of default prescribing parameter values such that selecting the displayed information causes the associated medication to be added to the prescription list for the current patient with the parameters initialized to the specified values.

In an advertisement embodiment the system displays an advertisement for at least one medication that is associated with at least one of a currently selected medication, a currently displayed list of medications, or information about the patient. Furthermore, in an automatic advertisement embodiment, if the user selects the advertisement, the system adds the at least one advertised medication to the prescription list for the patient, including associated parameter values if any. In an info/automatic embodiment, an advertisement provides two means of activation. If the first is selected, the system displays additional information about the indicated at least one medication. If the second is selected, the system adds the at least one advertised medication to the prescription list for the patient, including associated parameter values if any.

In a managed care embodiment, the system displays information regarding at least one medication that is associated with at least one of a currently selected medication, a currently displayed list of medications, or information about the patient. Furthermore, in an automatic managed care embodiment, if the user selects an interface associated with the information, the system adds the at least one medication to the prescription list for the patient, including associated parameter values if any.

In an info/automatic embodiment, the information displayed provides two means of activation. If the first is selected, the system displays additional information about the indicated at least one medication. If the second is selected, the system adds the at least one advertised medication to the prescription list for the patient, including associated parameter values if any. In one embodiment, the information describes a generic alternative to a selected medication. In one embodiment, the information describes a formulary alternative to a selected medication by describing a medication that is on the current patient's payor's formulary. In one embodiment, the information describes a step therapy treatment strategy that specifies that for a given diagnosis, drug A is preferred over drug B unless drug A has already been tried and has failed to successfully treat the patient.

### Electronic Prescription Pad Embodiments

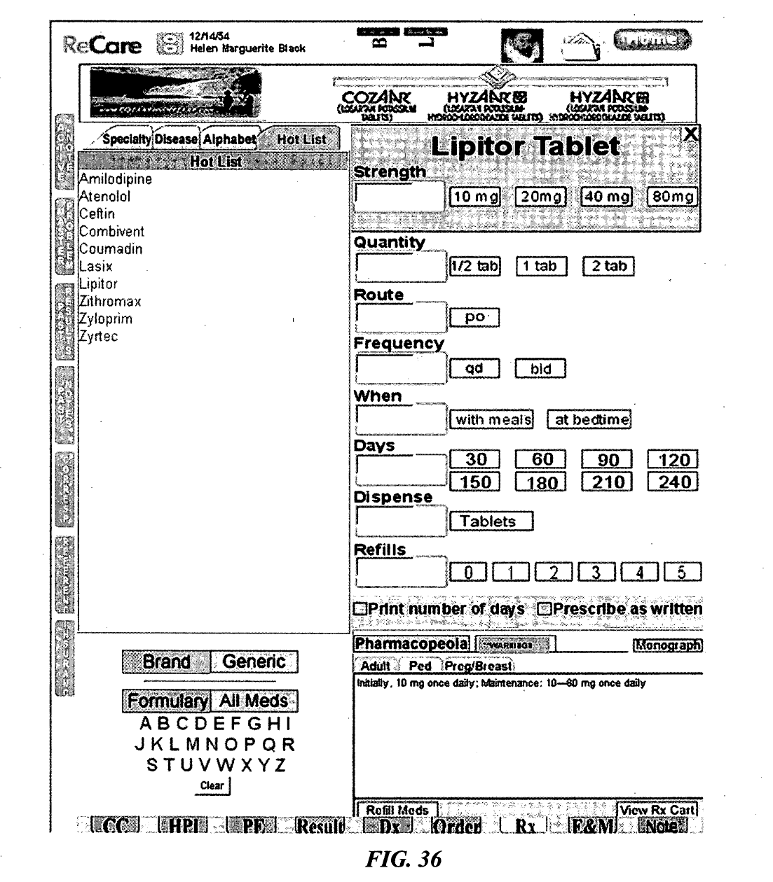

The message pad, seen these figures on the bottom right of the screen, may provide information and guidelines for a given medication. FIG. 35 depicts the guidelines for a medication Coumadin for an adult. This information may change as a new medication is selected as seen in FIG. 36. FIG. 8 depicts similar information to that of FIG. 35 with the prescription for unfilled.

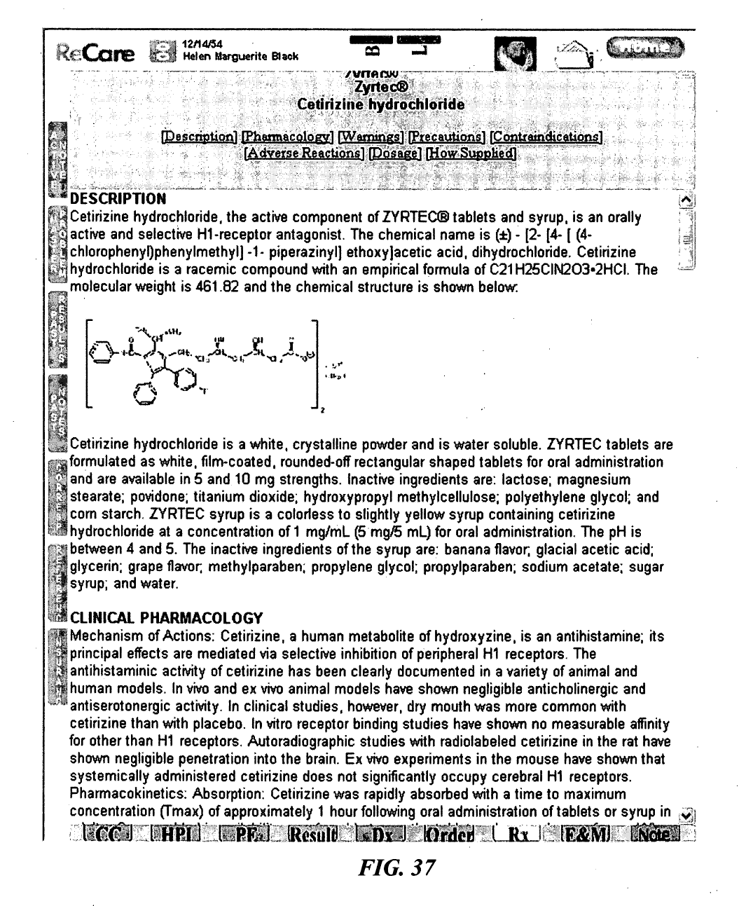

The prescription pad may also provide easy access to information and research associated with medications. This access may be provided through tabs, buttons, or links associated with advertisements, among others. FIG. 37 shows exemplary information about Zyrtec that may be accessed through an advertisement as seen in FIG. 19. The screen may also provide easy return access to the prescription area.

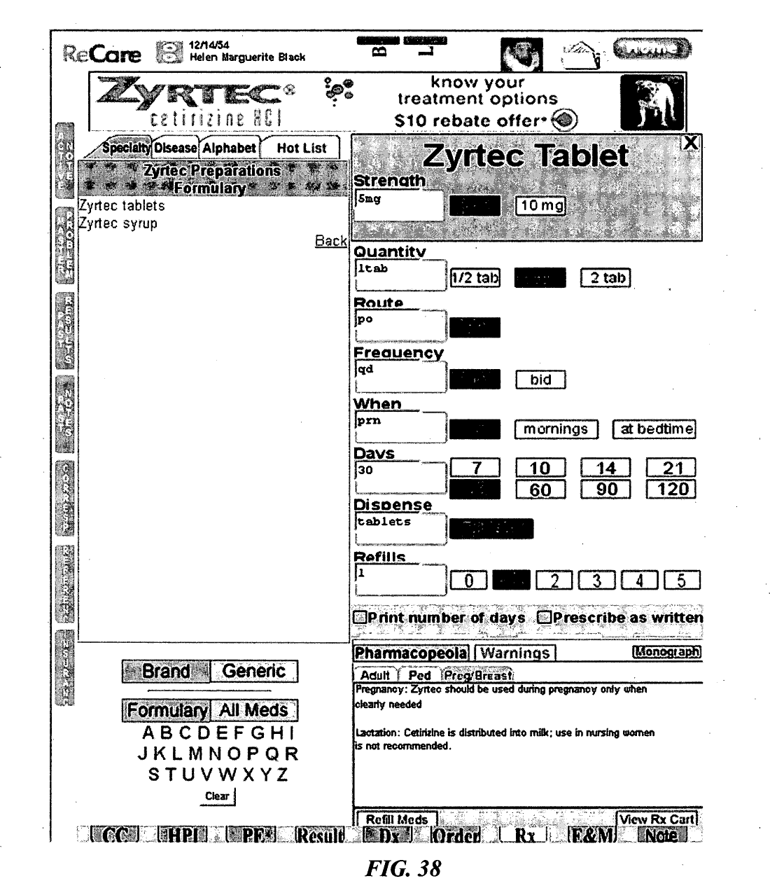

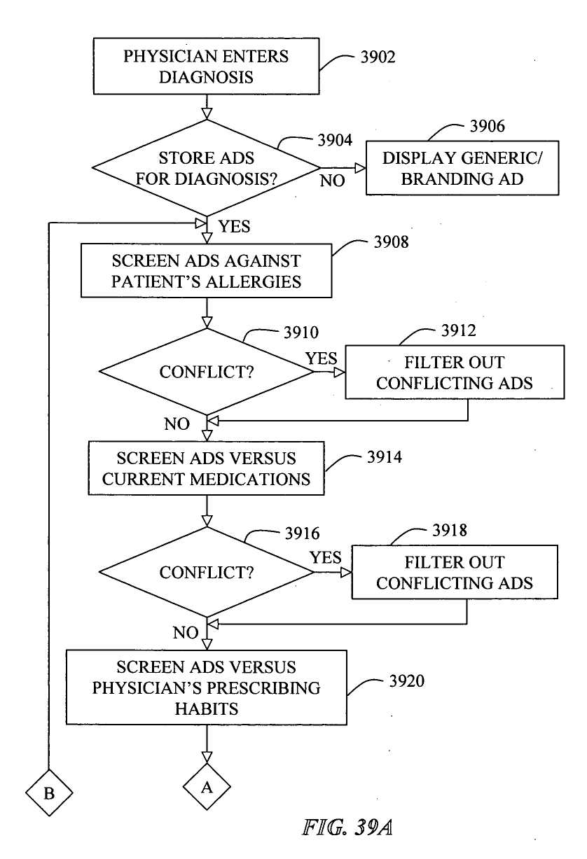

FIGS. 25 and 38 also depict the various messages that may be displayed in the message box. In FIG. 25, pediatric information is displayed and in FIG. 38, pregnant/breast-feeding information is displayed.

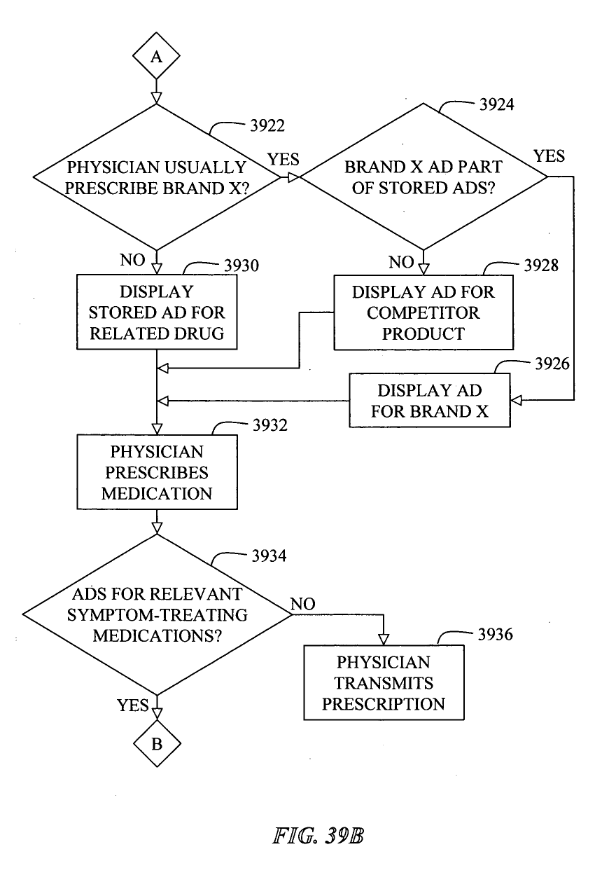

FIGS. 39A and 39B are a flowchart of the healthcare information manager process for selecting healthcare advertisements to be displayed after the healthcare worker enters a diagnosis of a patient. The healthcare worker, in this case a physician, enters a patient diagnosis 3902. If there are no stored advertisements available for this diagnosis, as determined in step 3904, the system displays a generic advertisement, as shown in step 3906. If there are stored advertisements available for this diagnosis that include prescription drugs used for treating the medical condition, the advertisements for those prescription drugs are screened against a list of patient's allergies, as shown at step 3908. If the patient is allergic to one or more of the prescription drugs indicating a conflict, as determined at step 3910, the advertisements for the conflicting drugs are filtered, as shown at step 3912. Filtering an advertisement may disqualify the advertisements so that it will not be displayed, reduce the probability that the advertisement will be displayed, select a related advertisement for display, attach a warning messaged that will be displayed along with the advertisement or take some other appropriate action. In either case, the advertisements are screened against the patient's current medications, as shown at step 3914. If the there is a conflict between the patient's current medications and the advertisements for the prescription drugs used to treat the patient's condition, as shown at step 3916, the advertisements for the conflicting drugs are filtered, as shown at step 3918. In either case, the advertisements are screened against the physician's prescribing habits for the patient's diagnosis, as shown at step 3920.

If the physician usually prescribes a certain brand (called Brand X), as determined in step 3922, and Brand X is included as one of the stored advertisements, as determined in step 3924, the system can display the advertisement for Brand X, as shown at step 3926. If Brand X is not included as one of the selected advertisements or if a competitor has purchased an advertisement, the system displays an advertisement Brand Y, as shown at step 3928.

If the physician does not usually prescribes Brand X, the system displays the stored advertisement(s) that most closely fits with the patient's diagnosis, allergies, current medication and physician's prescribing habits for this diagnosis, as shown at step 3930, or a competitors advertisement. The physician then prescribes the medication, as shown at step 3932. The physician may choose to select one of the advertised medications or not. If there are additional stored advertisements for relevant symptom treating medications, as determined at step 3934, the process is repeated at step 3908. Otherwise, the physician transmits the prescriptions, as shown at step 3936, to a pharmacy for filling.

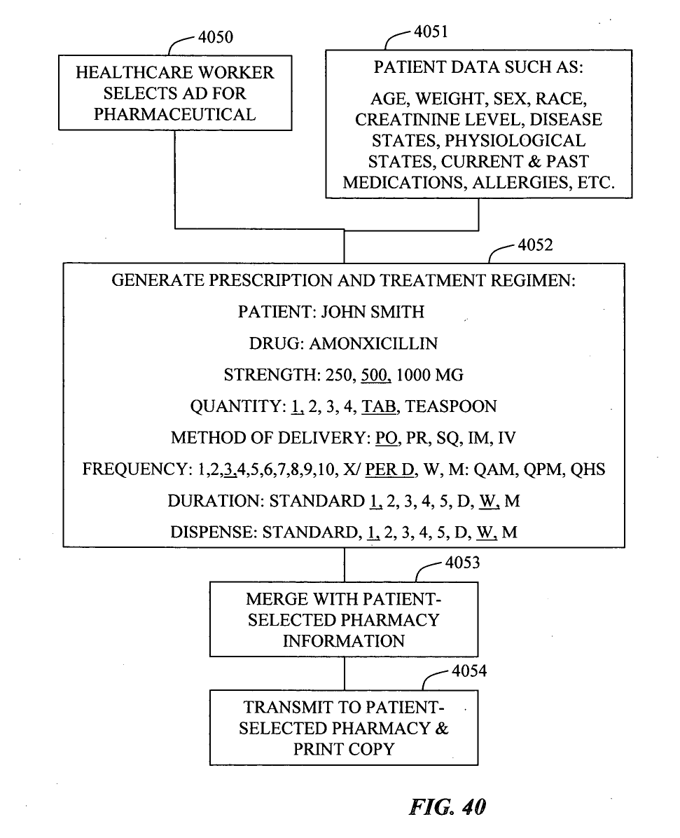

FIG. 40 is a block diagram of the process of automatically writing a prescription for a patient. An advertisement for a medication (usually a prescription drug) that is appropriate for the patient's disease, or complaint, or condition is displayed as discussed above in FIGS. 39A and 39B. This can occur at any point in the healthcare worker's workflow. The healthcare worker, usually a physician, can select the advertisement at any time during the physician-patient encounter including during telephone calls, or when the patient is not in the physician's presence. Selection, as depicted in block 4050, can be accomplished in any number of ways, including but not limited to a point and click device or a light pen. Patient data and other information 4051 available from the patient medical record (which may have been entered into the medical record by the patient, the physician, other medical staff, or other non-medical staff) such as the patient's age, weight, sex, race, creatinine level, disease states (such as kidney or liver disease or the like), physiological states such as diabetes, hypertension or the like, current medications, past medications, allergies, and other patient medical information 4051 is merged and integrated with the advertised prescription selected by the physician to generate the prescription and treatment regimen 4052. The system is able to select an appropriate treatment regimen including strength, quantity, method of delivery, frequency, and duration of treatment in light of the patient's physiologic/medical state 4052. For example, if a physician selects amoxicillin for a healthy adult, the system may suggest a standard adult regimen that might include 500 mg tablets three times a day for 7 days. On the other hand, a patient with an elevated creatinine level might receive a modified regimen that could include 250 mg tablets three times a day for 7 days. An appropriate treatment regimen for a child would be based on the child's weight, and could include 1 teaspoon of 125 mg/ml amoxicillin three times a day. The patient-selected pharmacy information 4053 is used to transmit the prescription to the appropriate pharmacy 4054. The pharmacy may be a traditional “brick and mortar” pharmacy or may be an Internet based pharmacy. The transmission can be via the global communications network or if the prescription is to be transmitted to a traditional brick and mortar pharmacy, transmission can occur via phone or fax. The prescription can also be printed. The physician can also select the advertisement to request more information about the pharmaceutical prior to making a prescribing decision.

### Groups of Treatments Embodiments

In some cases, doctors tend to prescribe the most critical/obvious drug for a disease or diagnosis, but often a patient has a set of related issues that must all be addressed. The groups of treatments embodiment helps ensure that a doctor addresses all of the related problems to treat the patient by streamlining the process of prescribing multiple medications.

In this embodiment, the system displays a multicategory list of medications and/or categories where the medications and/or categories span multiple categories where all categories represented on one multicategory list are relevant to one diagnosis, disease, condition, or syndrome. In the practice of medicine, medications are grouped into recognized categories such as Anti-Infectives (Antibiotics, Antivirals, Antifungals, other Anti-Infectives), Anticonvulsants, Arthritis Drugs, Attention Deficit/Hyperactivity Disorder (ADHD) Drugs, Cancer Drugs, and so on. A multicategory list is one of (a) a list of medications including at least one medication from at least two different categories of medications, (b) a list of categories including at least two categories of medication, or (c) a list of categories and medications including at least two categories or at least one medication from at least two different categories or at least one medication from a first category and at least one second category where the first category differs from the second category. In one embodiment, a multicategory list representing medications associated with one diagnosis, disease, condition, or syndrome is displayed at the same time as at least one medication or category that is not relevant to that diagnosis, disease, condition, or syndrome.

Although multicategory lists are described in terms of lists of medications, a multicategory list can accommodate other forms of treatment such as counseling, schedule for follow up visit, lab order, radiology order, test order, or send information.

In an embodiment of the system, a multicategory list is displayed to the user with medications organized by category.

In a list of categories embodiment, at least one category in a multicategory list is associated with a separate list of medications from the at least one category. In one embodiment, when the system displays a multicategory list, the user may select a category from the list causing the system to display a list of medications from the selected category.

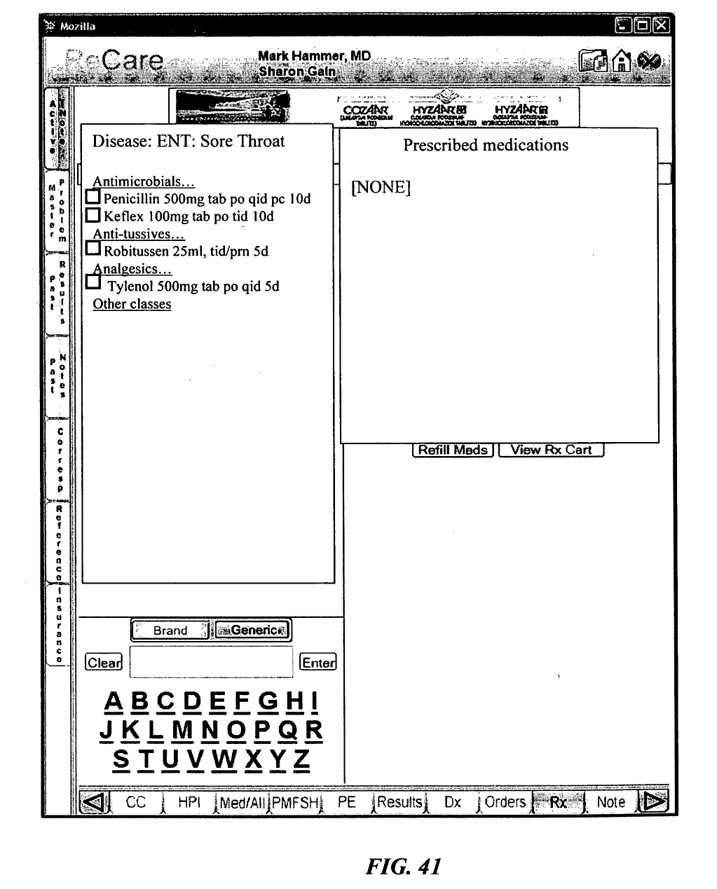

In a preferred medications embodiment, a multicategory list includes at least one category for which (a) at least one medication is displayed and (b) the category is displayed. Typically, the at least one displayed medication is a commonly-prescribed medication from the category or a medication that is preferred over other medications in the category in the current situation. In this embodiment, selecting a listed medication causes the system to add the selected medication to the prescription being constructed for the patient and selecting a category causes the system to display at least one additional medication from the selected category. FIG. 41 illustrates a preferred multicategory list where penicillin and keflex are preferred antimicrobials that can be prescribed by selecting the associated boxes to the left of each and where additional antimicrobials may be listed by selecting the hyperlink antimicrobials.

In a automatic parameter embodiment, at least one medication in at least one category associated with a multicategory list is associated with at least one parameter value such that selecting the medication causes the medication to be added to the prescription being constructed for the patient with the associated parameter values set.

In a select multiple embodiment, a multicategory list has a select-all trigger that the user may activate to add multiple medications to the prescription currently being assembled for the patient.

In a static navigation embodiment, at least one multicategory list is static in that it does not depend on patient information; instead, it may be navigated to by the user regardless of the patient. In one hotlist item embodiment, a multicategory list appears as a single entry on a hotlist (e.g., “standard pharyngitis regimin”) such that selecting that entry causes the multilist to be displayed or (in another embodiment) immediately added to the list of medications being prescribed for the patient. In one disease navigation embodiment, a user may select a disease and the system displays a multicategory list of medications associated with the disease. FIG. 41 illustrates a multicategory list for the disease “Sore throat”.

In a dynamic navigation embodiment, at least one multicategory list is dynamic in that it depends on patient information. For example, in a patient diagnosis embodiment, when the user enters the prescription pad subsystem, the screen displays a multicategory list associated with the diagnosis of the patient. For example, in a dynamic formulary embodiment, the system displays a multicategory list that lists as preferred medications that appear on the patient's payor's formulary. For example, in a contra-indications embodiment, the system displays a multicategory list that lists as preferred medications that are not contra-indicated for the patient. For example, in a dynamic automatic parameter value embodiment, the system associates with at least one medication at least one parameter value that depends on information about the patient such as the patient's age, gender, or creatinine level. In these embodiments, the system internally stores with the multicategory list a set of functions over the list and patient information such that the appropriate medications or parameters can be selected for each patient. In one embodiment, these functions are Boolean functions. In another embodiment, these functions represent select, filter, and sort functions such as those described in the context of FIG. 11.

### Further embodiments enhancing “Transmit Rx”

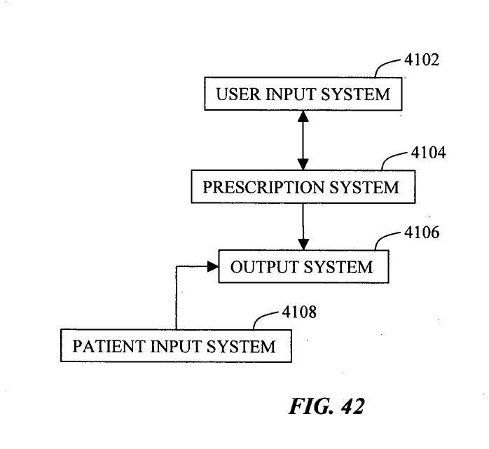

In an embodiment, an interface for selecting the pharmacy to which medications are sent is provided. In one embodiment, this interface is part of a patient input system 4108 as illustrated in FIG. 42. In one embodiment, the patient input system runs on a wireless terminal in the clinic. In another embodiment, the patient input system runs on a patient's home machine.

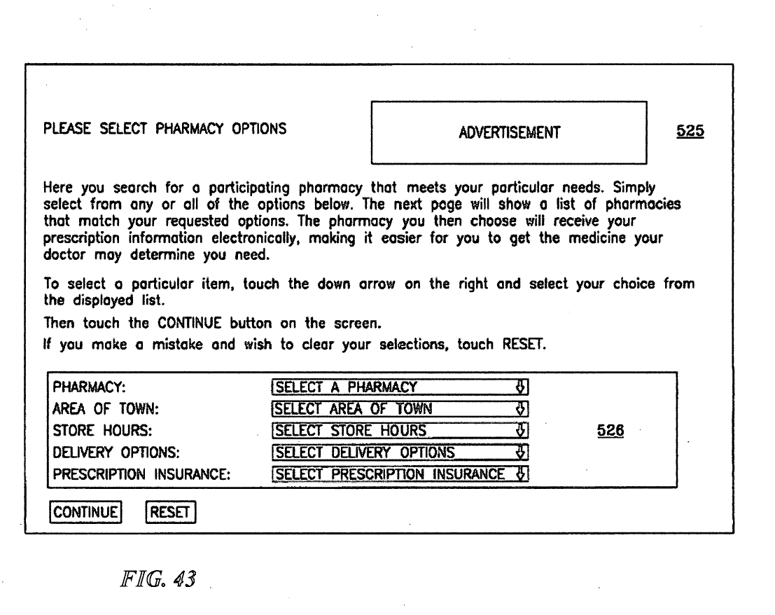

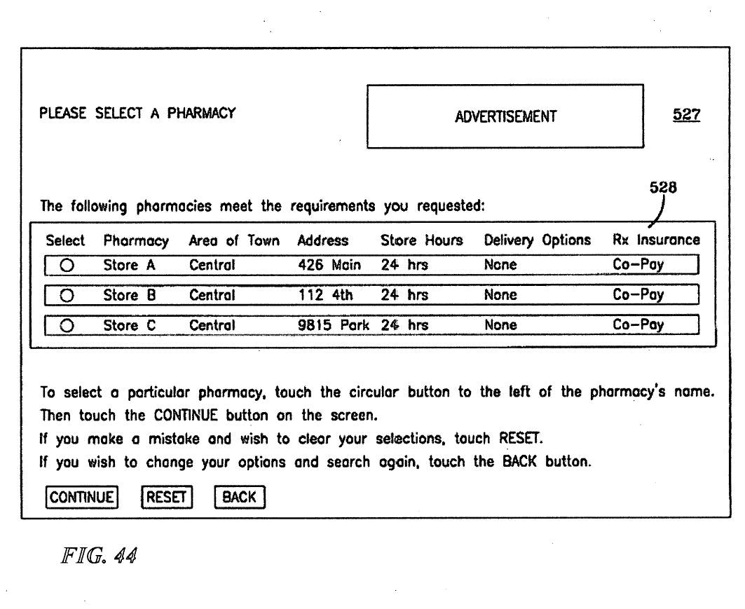

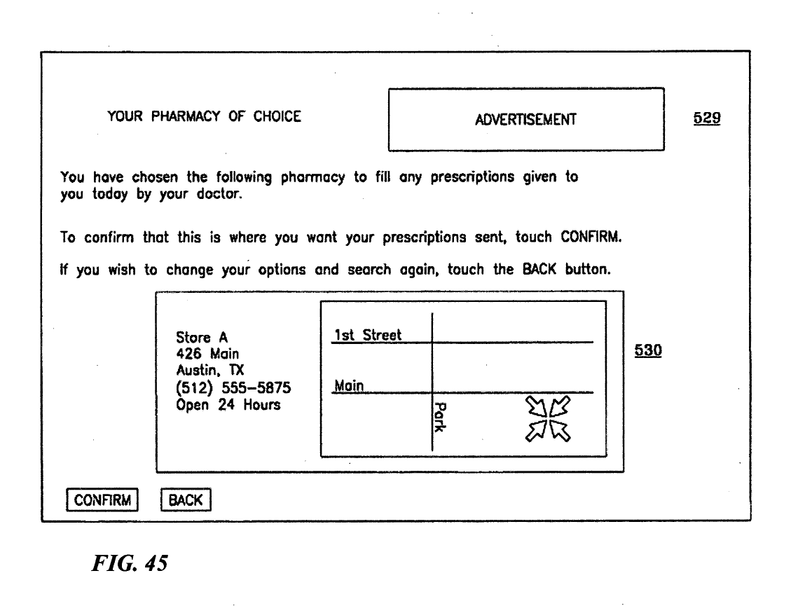

In an embodiment, the patient input system provides a pharmacy selection screen. FIG. 43 is a pictorial screen diagram illustrative of a pharmacy selection screen. This screen 525 may be used by a patient to enter selection criteria 526. The health information manager performs an analysis of the selection criteria 526 to determine specific pharmacies that meet or most nearly meet the patient's criteria. FIG. 44 is a pictorial screen diagram illustrative of a selected pharmacy display screen 527. The specific pharmacies 528 are listed on a pharmacy display screen shown. FIG. 45 is a pictorial screen diagram illustrative of a pharmacy map screen 529. The specific pharmacy selected by the patient in FIG. 44 is shown on the map 530.

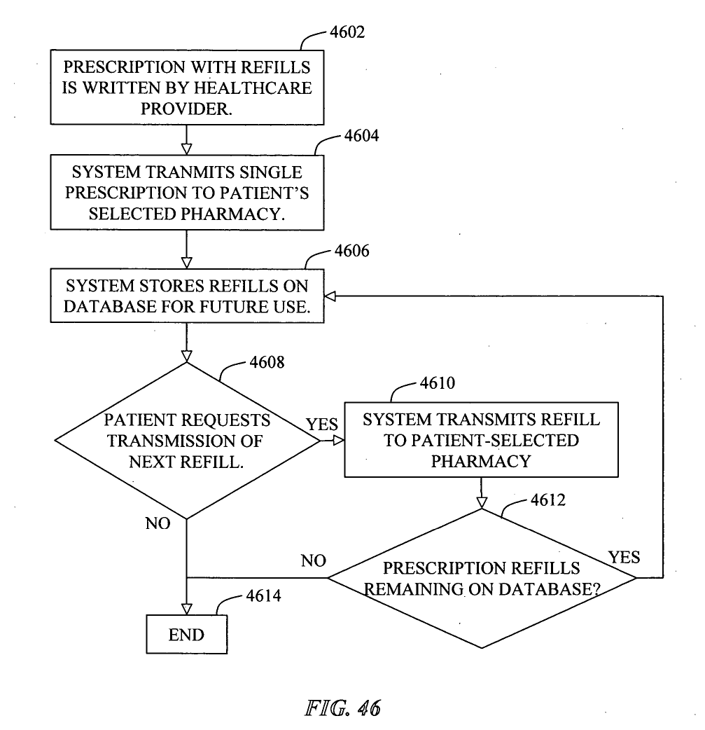

FIG. 46 is a flowchart of the process of storing refills of a prescription for future use. Typically, when a physician writes a prescription for a patient which includes refills, the pharmacy that fills the initial prescription gains “rights” to fill the remaining refills, thus “cornering the market” on the refill options for that particular prescription order. In the present system and method, when a physician writes a prescription order that includes refills, those “refill options” are electronically stored in a database and only a single prescription order is sent on to the selected pharmacy for fulfillment. Therefore, when the time comes to refill the prescription, the patient, not the initial filling pharmacy, has control over those refill options. For example, the patient may elect to send the first refill order to a pharmacy near the patient's home, the second refill to a pharmacy near the patient's office, and the third refill to an Internet-based pharmacy. This allows the patient to shop for the greatest convenience and/or value for refill prescriptions, rather than being tied to the pharmacy that filled the initial order. The system also prevents a patient from refilling a prescription before the stated time allotment on the previous prescription order has expired. In other words, a patient can't send refills to more than one pharmacy at a time, nor can he submit a refill order before his current order (for example, a 30-day medication supply) passes its 30-day waiting period.

In the process of FIG. 46, a prescription with refills exists within the computer system, as shown at step 4602. The system transmits an order for a single medication supply (meaning without refills) to a pharmacy, as shown at step 4604. The pharmacy may be a brick and mortar pharmacy or may be an Internet based pharmacy. The transmission may occur electronically using a communications network. The system stores the refills in a database for future use, as shown at step 4606. If the patient requests refills, as shown at step 4608, the system transmits refills to a patient-selected pharmacy, as shown at step 4610, which may be a different pharmacy than the pharmacy that filled the original medication supply and may be different from the pharmacy that filled other refills of this prescription. If there are refills left on the prescription, as shown at step 4612, the process repeats at step 4606. Otherwise the process ends, as shown at step 4614.

In an embodiment, when the prescription is sent by the output system to a pharmacy (via electronic transmission, printer, fax, or other means), the system also sends the prescription to a payor.

In an embodiment, if a patient fails to pick up a prescribed medication at a pharmacy or fails to order an expected refill, during the next patient visit to the clinic, the system displays to the user an alert indicating that fact.

### Further Embodiments Enhancing “Entering Patient Information”

### EMR Embodiments

In an embodiment, the system allows entry of information about a patient beyond prescribing medications for the patient.

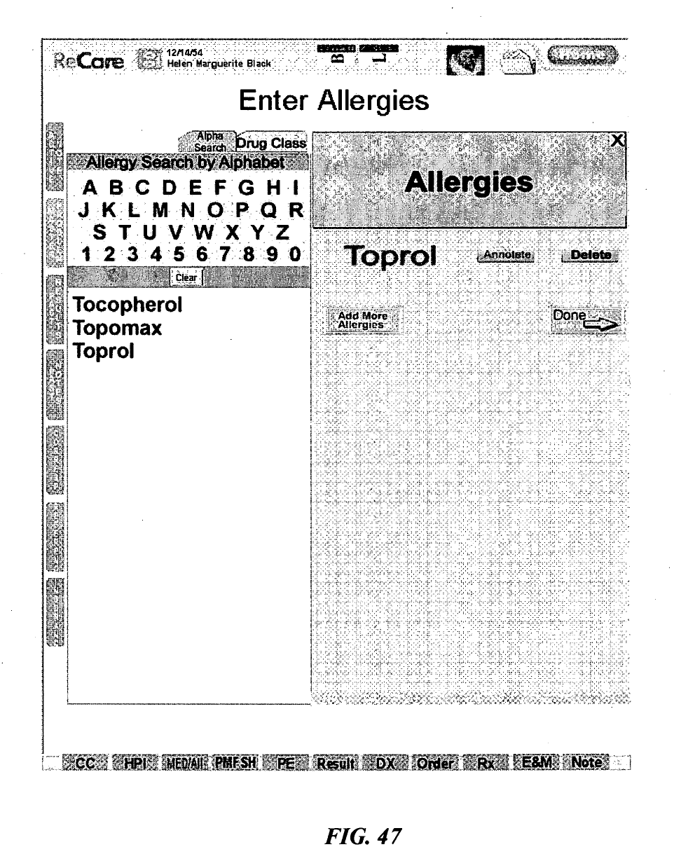

FIG. 47 depicts the entry of allergies to medications. If a master problem tab is selected, medication allergies may be entered. The medications may be selected alphabetically or through other organizational means. In addition, classes of drugs may be selected and listed as the source of allergic reactions.

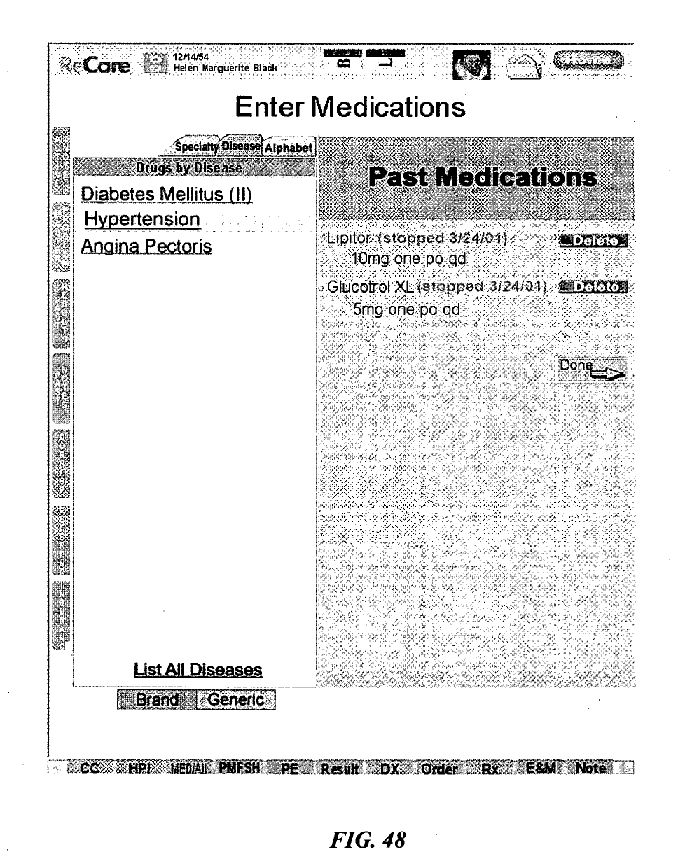

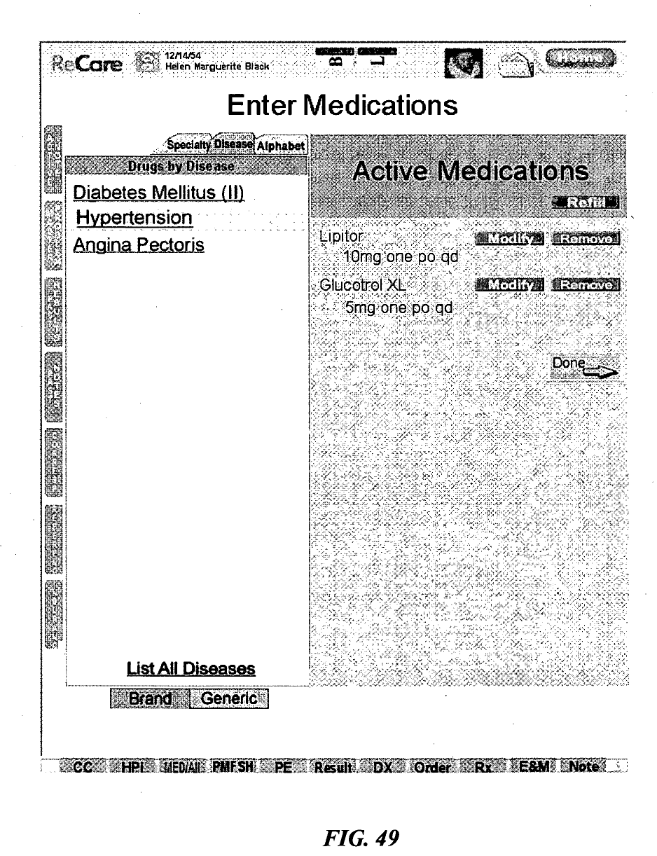

Under the master problems tab as seen in FIG. 47, a medical professional may also access past medications through specialty, disease, and alphabetic lists. For example, as seen in FIG. 48, the doctor may select hypertension to see what has been tried in the past to treat the ailment. In another example, as seen in FIG. 49, a medical professional may access present medications and provide for refills.

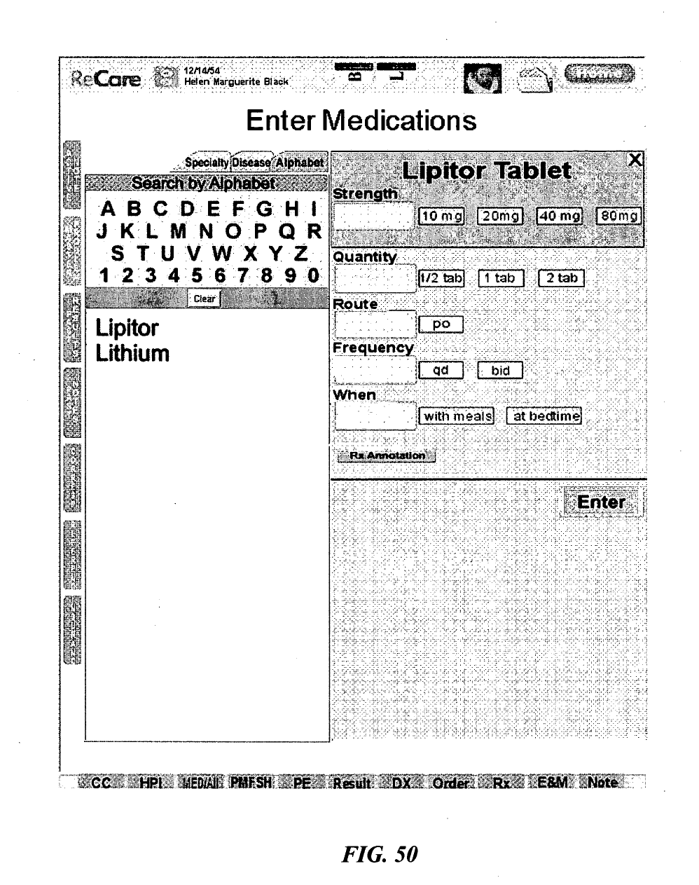

FIG. 50 represents a method for entering past medications into the system.

However, various methods may be used to enter data. In addition, various arrangements of the information and data entry methods may be envisaged. Further, various means of delivering and storing a prescription may be envisioned.

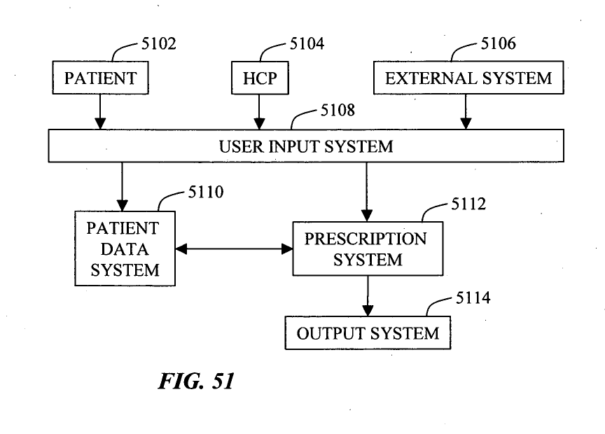

In an embodiment, the prescription system is integrated with an electronic medical record system (EMR) such that a wide range of information about a patient including chief complaint, history of present illness, review of systems, physical exam, laboratory/test/radiology results, diagnosis, coding, narrative, current medications, allergies, past medications, active problems, family medical and social history, demographics, and payor information may be entered. FIG. 51 illustrates an EMR system in which a single user input system provides a unified interface to the prescription system and the rest of the patient data system. Furthermore, in this embodiment, data to the EMR system is provided by the HCP 5104 (health care provider, e.g., doctor, nurse, technician), by the patient 5102, and by external systems 5106. In this embodiment, the patient supplies pharmacy selection information as well as other information (reason for visit, allergies, review of systems questionnaire.) External systems 5106 provide other data about the patient (e.g., formularies from payors, lab results from labs, alerts from pharmacies.) The data may be stored in the patient data system 5110. The prescription system 5112 may interact with the user input system 5108 and the patient data system 5110 to aid in preparing a prescription that is transmitted by the output system 5114.

### Further Embodiments Enhancing “System Maintenance”

In an embodiment, a network-connected system maintenance module updates the system's database of medications, medication selection logic, as well as any parameter values associated with medications. These updates may be periodic (e.g., 1/day) or episodic (e.g., whenever a new medication is approved by the FDA.)

In an advertising billing embodiment, the system tracks at least one of the number of times that advertisements are viewed, the number of times advertisements are selected, or the number of times that advertised medications are prescribed. In this embodiment, information is sent from more than one clinic installation to at least one system support installation that is remote from at least one clinic installation. This at least one support installation thus accumulates advertising statistics from multiple clinics.

In one direct billing embodiment, the at least one support installation transmits subsets of advertising statistics to different external advertising customer computers.

In an information tracking embodiment, the system tracks at least one of the number of times that at least one information item regarding at least one medication viewed, the number of times such items are selected, or the number of times that medications relating to such items are prescribed. In this embodiment, this information is sent from more than one clinic installation to at least one system support installation that is remote from at least one clinic installation. This at least one support installation thus accumulates information statistics from multiple clinics.

The description discloses a system for preparing a prescription. The system may include a server and database. The server and database may function to provide data for use by an interface device. The interface device may, for example, be a wireless device, a laptop, a desktop computer, or other smart device. The server and database store the data and rules associated with the prescription system. The interface device may access the server and database through login or encrypted access.

The description discloses methods for advertising through the prescription pad. Advertisements may be delivered to the device in reaction to activity by the medical professional. Requests for interfaces may be interpreted by the server and database to ascertain the relevance of an advertisement. The server may then provide the advertisement from a set of stored advertisement or may access other servers and databases to acquire the desired advertisement.

The description discloses a taper button for providing complex prescriptions that vary over time. Additional aspects of the invention may be found in a method for accessing and transferring prescription information to a pharmacy.

The description discloses a method for organizing medications to be prescribed in one or more groups of medications to improve the efficiency of prescribing. The description discloses a method for automatically selecting prescribing parameter values relevant to a medication being prescribed for a patient. The description discloses a method for displaying information relevant to a medication being prescribed. The description discloses a method for prescribing groups of medications from multiple medication categories.

The figures and description described exemplary interface screens. These screens may be updated, modified, and enhanced using enhanced graphics, reorganized elements, and multimedia elements.

The above disclosed subject matter is to be considered illustrative, and not restrictive, and the appended claims are intended to cover all such modifications, enhancements, and other embodiments which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An electronic device comprising:
a touch responsive display; and
a graphical user interface (GUI) engine operable to initiate presentation of a GUI on the display, the GUI comprising a first portion presenting a menu-based interface and a second portion having an area for receiving a prescription input comprising a handwritten character.

2. The device of claim 1, wherein the GUI further comprises a virtual keyboard interface.

3. The device of claim 1, wherein the GUI further comprises a “hot list” of medications.

4. The device of claim 1, wherein the GUI further comprises an alphabetical listing of medications.

5. The device of claim 1, wherein the GUI further comprises a listing based on a patient condition.

6. The device of claim 1, wherein the GUI further comprises a sublisting based on drug category.

7. The device of claim 1, further comprising a writing implement.

8. The device of claim 1, further comprising a control element configured to implement a tapered prescription.

9. The device of claim 1, wherein the GUI is configured to provide a list of the at least two medications associated with a given prescription.

10. A prescription system comprising:
a processor;
a database accessible by the processor; and
a storage medium comprising:
instructions operable to direct the processor to access the database and to acquire a list of medications;
instructions operable to direct the processor to generate a menu based interface based on the list of medications for preparing a prescription; and
instructions operable to direct the processor to generate a handwriting recognition interface for preparing the prescription.

11. The prescription system of claim 10, further comprising instructions to provide a virtual keyboard interface.

12. The prescription system of claim 10, wherein the menu based interface includes a “hot list” of medications.

13. The prescription system of claim 10, wherein the menu based interface includes an alphabetical listing of medications.

14. The prescription system of claim 10, wherein the menu based interface includes a listing based on a patient condition.

15. The prescription system of claim 10, wherein the menu based interface includes a sublisting based on drug category.

16. The prescription system of claim 10, wherein at least one of the menu based interface and the handwriting recognition interface further comprises a control element configured to implement a tapered prescription.

17. The prescription system of claim 10, wherein the prescription includes at least two medications and wherein at least one of the menu based interface and the handwriting recognition interface is configured to provide a list of the at least two medications.

18. A method of preparing a prescription, the method comprising:
accessing a database to acquire a list of medications;
generating a menu based interface based on the list of medications for preparing a prescription; and
generating a handwriting recognition interface for preparing the prescription.

19. The method of claim 18, further comprising providing a virtual keyboard interface.

20. The method of claim 18, wherein the menu based interface includes a “hot list” of medications.

21. The method of claim 18, wherein the menu based interface includes an alphabetical listing of medications.

22. The method of claim 18, wherein the menu based interface includes a listing based on a patient condition.

23. The method of claim 18, wherein the menu based interface includes a sublisting based on drug category.

24. The method of claim 18, wherein at least one of the menu based interface and the handwriting recognition interface further comprises a control element configured to implement a tapered prescription.

25. The method of claim 18, wherein the prescription includes at least two medications and wherein at least one of the menu based interface and the handwriting recognition interface is configured to provide a list of the at least two medications.

26. The method of claim 18, further comprising accessing at least one user interface device and at least one output system via a network interface.
